(19) United States
(12) Patent Application Publication
(10) Pub. No.: US 2025/0031171 A1
(43) Pub. Date: Jan. 23, 2025

(54) PRESERVATION OF SESSION CONTEXT IN A COMMUNICATIONS NETWORK

(71) Applicant: InterDigital Patent Holdings, Inc., Wilmington, DE (US)

(72) Inventors: Michael Starsinic, Newtown, PA (US); Quang Ly, North Wales, PA (US); Catalina Mladin, Hatboro, PA (US); Jiwan Ninglekhu, Royersford, PA (US); Pascal Adjakple, Great Neck, NY (US); Kyle Jung-Lin Pan, Saint James, NY (US)

(73) Assignee: InterDigital Patent Holdings, Inc., Wilmington, DE (US)

(21) Appl. No.: 18/707,094

(22) PCT Filed: Nov. 3, 2022
(86) PCT No.: PCT/US2022/079239

§ 371 Date: May 2, 2024

Related U.S. Application Data
(60) Provisional application No. 63/275,084, filed on Nov. 3, 2021.

(51) Int. Cl. H04W 60/06; H04L 61/5007; H04L 65/1069

(52) U.S. Cl. CPC H04W 60/06; H04L 61/5007; H04L 65/1069

(57) ABSTRACT

A wireless transmit/receive unit (WTRU) may send to a network node a registration request message requesting to register with the network and indicating that the WTRU is capable of preserving, when the WTRU becomes unavailable to the network, context information associated with the communications between the WTRU and the network. The network node may indicate in a registration accept message that the network supports the preservation of context information when the WTRU becomes unavailable to the network. Based on a determination that the WTRU will become unavailable to the network, the WTRU may send to the network a message indicating a request to preserve the context information. The message may comprise an indication of a time period during which the WTRU will be unavailable.

### CROSS-REFERENCE TO RELATED APPLICATIONS

This application claims the benefit of U.S. Provisional Patent Application No. 63/275,084, filed Nov. 3, 2021, and entitled “Enhancements for Interactions between the Session Management and Mobility Management Layers,” the content of which is incorporated by reference herein in its entirety.

### BACKGROUND

In wireless communications systems, such as, for example, a system operating in accordance with Third Generation Partnership Project (3GPP) New Radio (NR) standards, events may occur that require deletion of mobility management context in a wireless transmit/receive unit (WTRU), such as a user equipment (UE), but that also cause deletion of session management context. For example, when there is an operating system (OS) update, a modem reset, or a network-initiated deregistration request, a WTRU's mobility management context may be cleared. However, such events may also cause the WTRU's session management context and application layer information to be deleted. This may result in inefficiencies.

### SUMMARY

Described herein are methods, apparatus, and systems for preserving session context in a communications network when an event triggers deletion of such context. A wireless transmit/receive unit (WTRU) may send to a network node a registration request message requesting to register with the network. The registration request message may comprise an indication that the WTRU is capable of preserving, when the WTRU becomes unavailable to the network, context information associated with communications between the WTRU and the network. The WTRU may receive from the network node a registration accept message that indicates that the network supports the preservation of context information when the WTRU becomes unavailable to the network. Based on a determination that the WTRU will become unavailable to the network, the WTRU may send to the network a first message indicating a request to preserve the context information. The first message may comprise an indication of a time period during which the WTRU will be unavailable. After the time period has ended, the WTRU may send to the network a second message indicating that the WTRU is again available to the network.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

A more detailed understanding may be had from the following description, given by way of example in conjunction with the accompanying drawings, in which:

FIG. 1 shows an example communication system;

FIG. 2 shows an example control plane between network entities;

FIG. 3 shows an example registration management (RM) state model in a UE;

FIG. 4 shows an example registration management (RM) state mode in an AMF;

FIG. 5 shows an example connection management (CM) state transition in a UE;

FIG. 6 shows an example connection management (CM) state transition in an AMF;

FIG. 7 shows an example control plane protocol stack between a UE and an SMF;

FIG. 8 shows an example UE-initiated deregistration method;

FIG. 9 shows an example network-initiated deregistration method;

FIG. 10 shows an example user plane protocol stack

FIGS. 11A-11D show an example UE-requested PDU session establishment method for non-roaming and roaming with local breakout;

FIGS. 12a-12c shows an example UE or network-requested PDU session modification (non-roaming and roaming with local breakout) method;

FIG. 13 shows an example context preservation and recovery method;

FIG. 14 shows an example enhanced RM state model for a UE and AMF;

FIG. 15A shows another example communications system;

FIGS. 15B-D show example radio access networks (RANs) and core networks;

FIG. 15E shows another example communications system;

FIG. 15F is a block diagram of an example apparatus or device, such as a wireless transmit/receive unit (WTRU); and

FIG. 15G shows an example computing system.

### DETAILED DESCRIPTION

A list of acronyms that may be used herein is provided in Table 1 below. In a NR (i.e., 5G) system, an N1 interface between a UE and an access and mobility management function (AMF) uses a non-access stratum (NAS) mobility management (MM) protocol (NAS-MM). As used herein, the terms “NAS-MM” and “NAS” (e.g. NAS with no suffix) may be used interchangeably. The N1 NAS signaling connection is used for both registration management and connection management (RM/CM) and for session management (SM)-related messages and procedures for a UE.

The UE also uses the N1 interface to communicate with other core network functions besides the AMF. When the UE uses the N1 interface to communicate with core network functions other than the AMF, the messages that are exchanged between the UE and the other network functions are carried on top of the NAS-MM protocol.

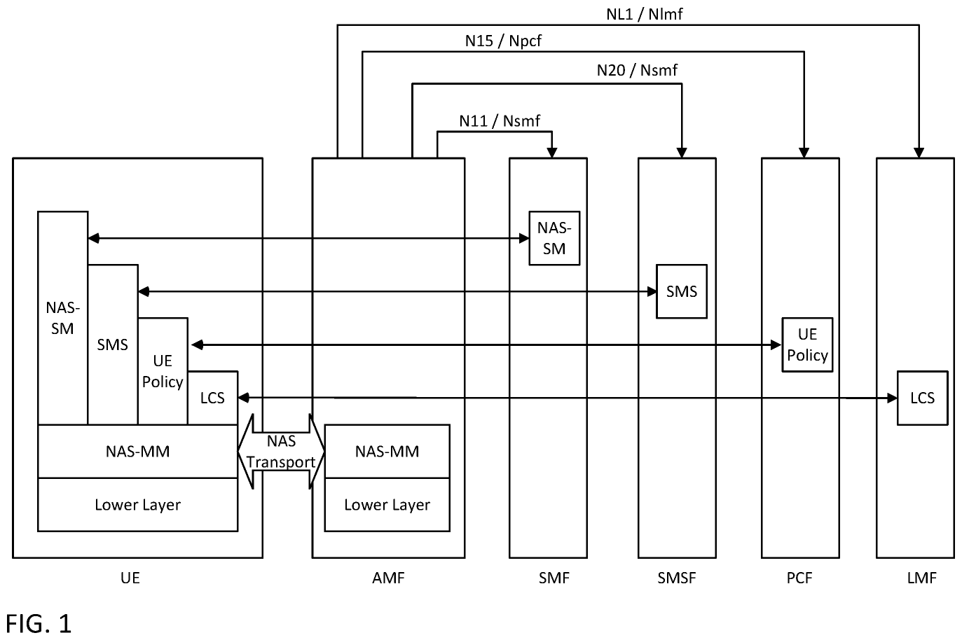

There are multiple cases of protocols between the UE and a core network function (excluding the AMF) that need to be transported over the N1 interface via the NAS-MM protocol. The other core network functions that the UE communicates with via the N1 interface are the session management function (SMF), short message service function (SMSF), policy control function (PCF), and location management function (LMF). FIG. 1 shows an example of these various network functions.

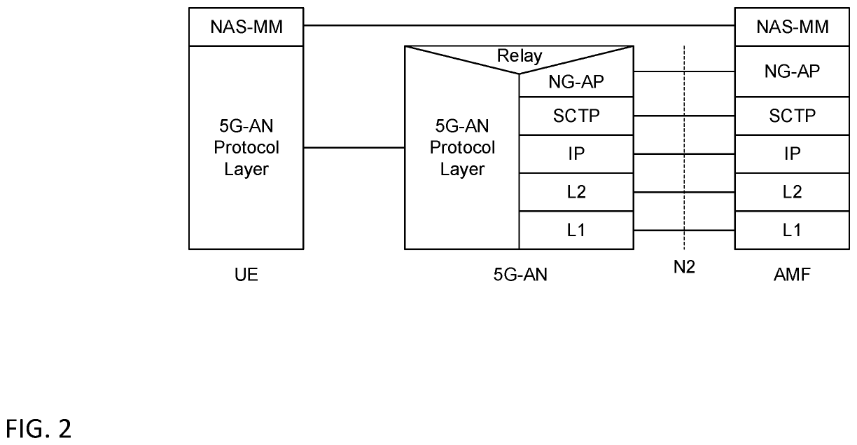

The NAS-MM protocol is used to execute procedures between the UE and AMF. The procedures that are executed between the UE and AMF may impact the UE's registration management (RM) and connection management (CM) state machines. The NAS-MM protocol is also used to send messages to the AMF that the AMF forwards to other network functions such as an SMF, SMSF, PCF, or LMF. The NAS-MM protocol is illustrated in FIG. 2. The 5G NAS-MM protocol is defined in 3GPP TS 24.501, Non-Access-Stratum (NAS) protocol for 5G System (5GS); Stage 3.

NAS-MM context is information that is stored in the UE and AMF that is necessary to maintain an N1 connection between the UE and AMF. NAS-MM context may include NAS security credentials and a 5G globally unique temporary identifier (GUTI).

A UE and AMF separately maintain a registration management (RM) state for the UE. The RM states are RM-DEREGISTERED and RM-REGISTERED. In the RM-DEREGISTERED state, the UE is not registered with the network. The UE context in the AMF holds no valid location or routing information for the UE so the UE is not reachable by the AMF. The UE may be considered unavailable. However, some parts of UE context may still be stored in the UE and the AMF, for example, to avoid running an authentication procedure during every registration procedure.

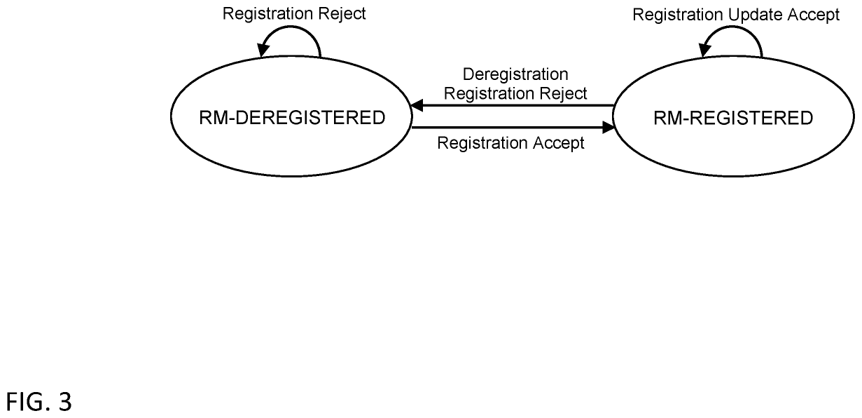

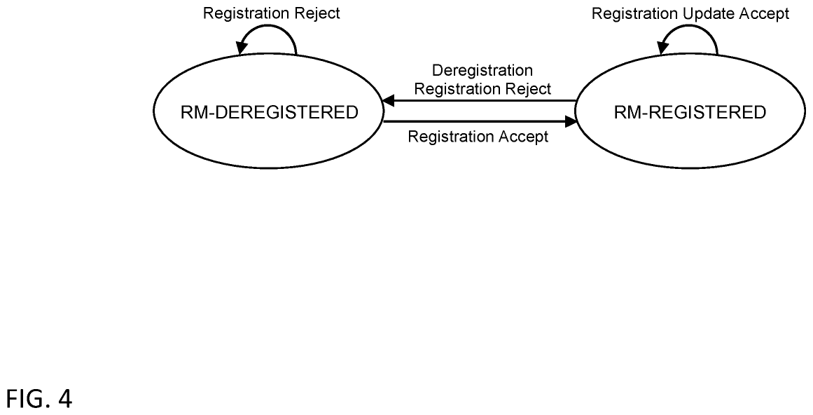

In the RM-DEREGISTERED state, the UE will attempt to register with the network. Once registration is accepted, the UE will move to the RM-REGISTERED state. In the RM-REGISTERED state, the UE is registered with the network and can receive services that require registration with the network. In the RM-REGISTERED state, the UE can perform registration updates and send service requests. If the UE performs a deregistration procedure or a registration request is rejected, the UE will move to or remain in the RM-DEREGISTERED state. The RM state in the UE is illustrated in FIG. 3. The RM state in the AMF is illustrated in FIG. 4.

The 5G MM substates of the RM-REGISTED state may also be called the 5G MM-REGISTERED state. The RM-DEREGISTED state may also be called the 5G MM-DEREGISTERED state. The substates of the 5G MM-REGISTERED and 5G MM-DEREGISTERED states are described in 3GPP TS 24.501.

Connection management (CM) involves establishing and releasing a NAS signaling connection between a UE and the AMF over the N1 interface. Two CM states are used to reflect the NAS signaling connection of the UE with the AMF. The two states are CM-IDLE and CM-CONNECTED. A UE may have two N1 connections to the same AMF; one connection over 3GPP access and another connection over non-3GPP access. Separate CM states are maintained for each access.

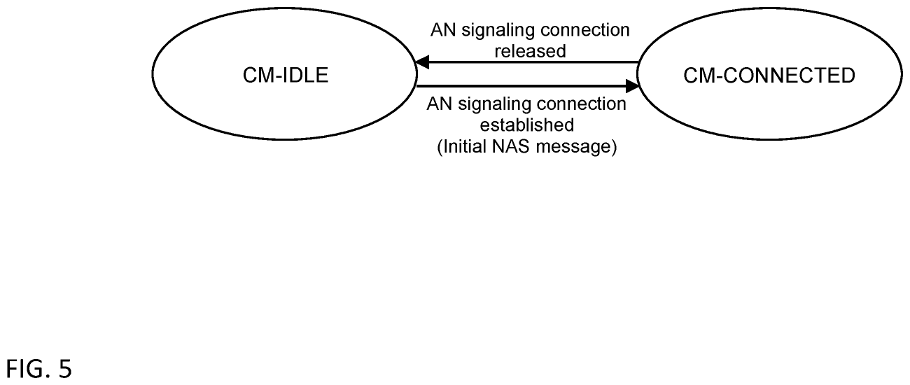

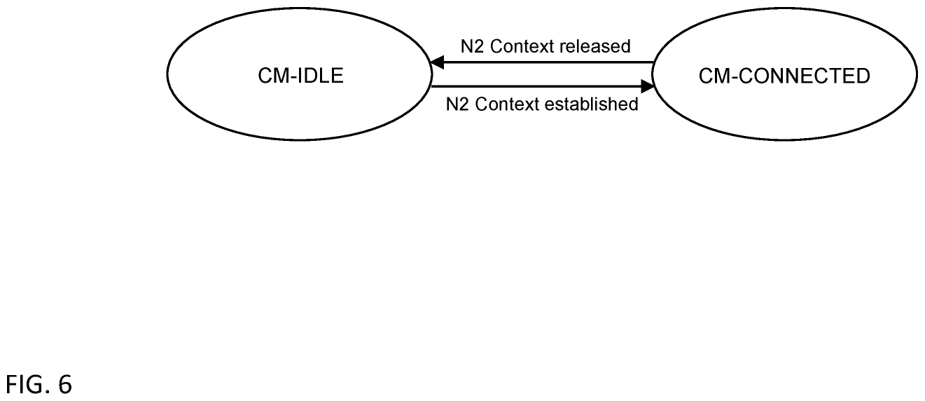

A UE in CM-IDLE state has no NAS signaling connection established with the AMF over N1. A UE in CM-CONNECTED state has a NAS signaling connection with the AMF over N1. A NAS signaling connection uses a radio resource control (RRC) connection between the UE and the next generation (NG) radio access network (RAN) and an NG application protocol (AP) UE association between the access network (AN) and the AMF for 3GPP access. The CM state in the UE is illustrated in FIG. 5. The CM state in the AMF is illustrated in FIG. 6.

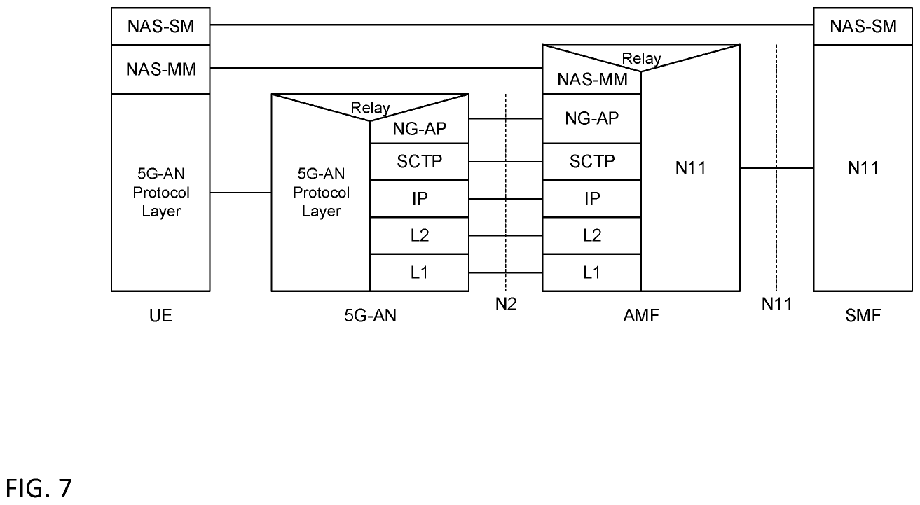

A non-access stratum (NAS) session management (SM) protocol (NAS-SM) is used to carry session management messages between the UE and a session management function (SMF). NAS-SM messages pass through, but are not interpreted by, the AMF. This is illustrated in FIG. 7.

When a UE establishes a protocol data unit (PDU) session, SM context is created. During the PDU session establishment procedure, the AMF invokes the SMF's Nsmf_PDUSession_CreateSMContext request service operation to request that the SMF creates SM context for the UE's requested PDU session. The SMF will send the Nsmf_PDUSession_CreateSMContext response to the AMF. The response includes an SM context identifier (ID) and an N1 message container. The SM context ID identifies the PDU session context that is stored in the SMF for the UE's PDU session. The N1 message container is the NAS-SM message that is sent to the UE on top of the NAS-MM messaging.

The SM context that is stored in the SMF is listed in Table 6.1.6.2.39-1 of 3GPP TS 29.502, 5G System; Session Management Services; Stage 3. The SM context includes the PDU session ID, the data network name (DNN), single network slice selection assistance information (S-NSSAI), and internet protocol (IP) address. The information in the SM context is associated with the PDU session.

The UE, AMF, RAN, PCF, or SMF may initiate the release of the PDU session. The UE sends a PDU session release request to the SMF via the N1 interface. In the N1 message, the UE will identify the PDU session with a PDU session ID. The AMF will forward the N1 message to the SMF by invoking the Nsmf_PDUSession_UpdateSMContext service operation. The SMF will then send an Nsmf_PDUSession_UpdateSMContext response to the AMF. The response will include an N2 SM resource release request and an N1 SM container. The N1 SM container includes a PDU session release command. The N2 SM resource release request is sent to the RAN by the AMF and the N1 SM container is a NAS-SM message that is sent to the UE by the AMF via the N1 interface. The Nsmf_PDUSession_UpdateSMContext response includes an N1 SM container that includes a PDU session release command, and an N2 SM resource release request that indicate to the AMF, UE, and RAN respectively that any context that is associated with the PDU session can be deleted.

The AMF may invoke the Nsmf_PDUSession_ReleaseSMContext service operation to request the release of the PDU session and cause the deletion of SM context in the UE, SMF, RAN, PCF, and AMF. The PCF may initiate an SM policy association termination procedure as defined in clause 4.16.6 of 3GPP TS 23.502, Procedures for the 5G System (5GS), Stage 2, to request the release of the PDU session and cause the deletion of SM context in the UE, SMF, RAN, PCF, and AMF. The RAN may send an N2 message to request the release of the PDU session and cause the deletion of SM context in the UE, SMF, RAN, PCF, and AMF.

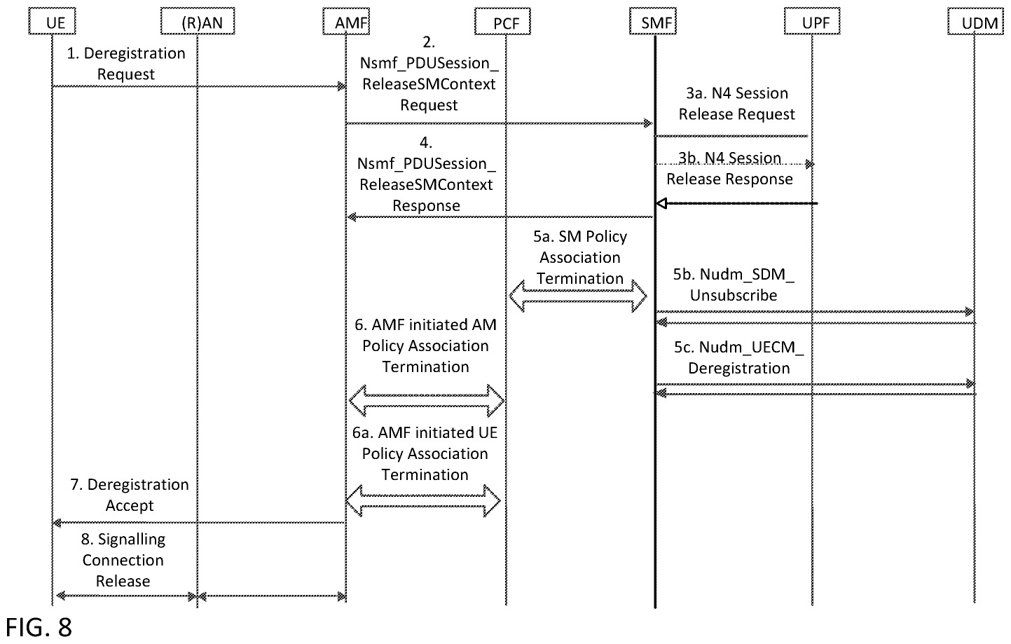

FIG. 8 shows a UE-initiated deregistration procedure. Note that when the UE sends a deregistration request to the network, the AMF will invoke the Nsmf_PDUSession_ReleaseSMContext Request service operation with any SMF for the which the UE has an established PDU session. This service invocation will cause the UE's SM context to be deleted in the SMF, the user plane function (UPF), and the unified data management (UDM). This is illustrated in FIG. 8, which shows that the AMF sends the Nsmf_PDUSession_ReleaseSMContext Request in step 2.

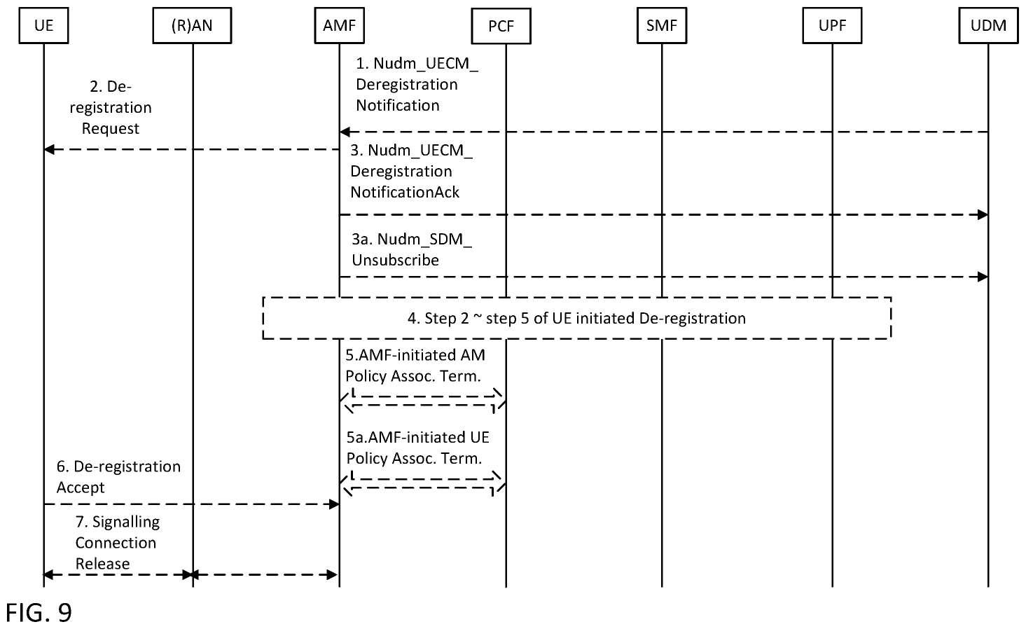

FIG. 9 shows a network-initiated deregistration procedure. In the network-initiated deregistration procedure, the AMF will also invoke the Nsmf_PDUSession_ReleaseSMContext request service operation with any SMF for the which the UE has an established PDU session. This service invocation will cause the UE's SM context to be deleted in the SMF, UPF, and UDM. This is illustrated in FIG. 9.

The 3GPP 5G core network architecture (5GC) supports a PDU connectivity service, which is a service that provides exchange of PDUs between a UE and a data network identified by a DNN. The PDU connectivity service is supported via PDU sessions that are established upon request from the UE. PDU sessions are established (upon UE request), modified (upon UE and 5GC request) and released (upon UE and 5GC request) using NAS SM signaling exchanged over the N1 interface between the UE and the SMF via AMF. Upon request from an application server (AS), the 5GC is able to trigger a specific application in the UE. When receiving that trigger message, the UE shall pass it to the identified application in the UE. The identified application in the UE may establish a PDU session to a specific DNN.

A PDU session is associated to an S-NSSAI and a DNN. In a PDU session establishment request sent to the network, the UE shall provide a PDU session identifier. The PDU session ID is unique per UE and is the identifier used to uniquely identify one of a UE's PDU sessions. A PDU session ID is stored in the UDM to support handover between 3GPP and non-3GPP accesses when different public land mobile networks (PLMNs) are used for the two accesses.

Each PDU session supports a single PDU session type, e.g., supports the exchange of a single type of PDU requested by the UE at the establishment of the PDU session. The following PDU session types are defined: IPv4, IPV6, IPv4v6, Ethernet, and Unstructured.

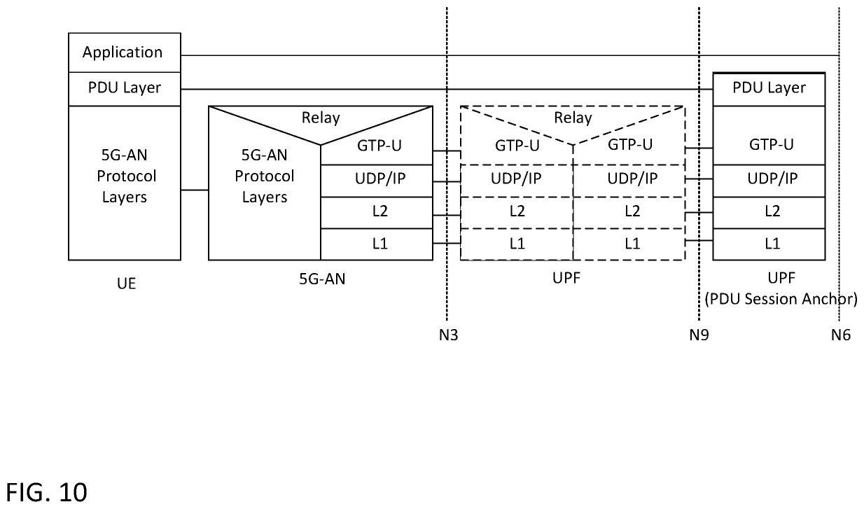

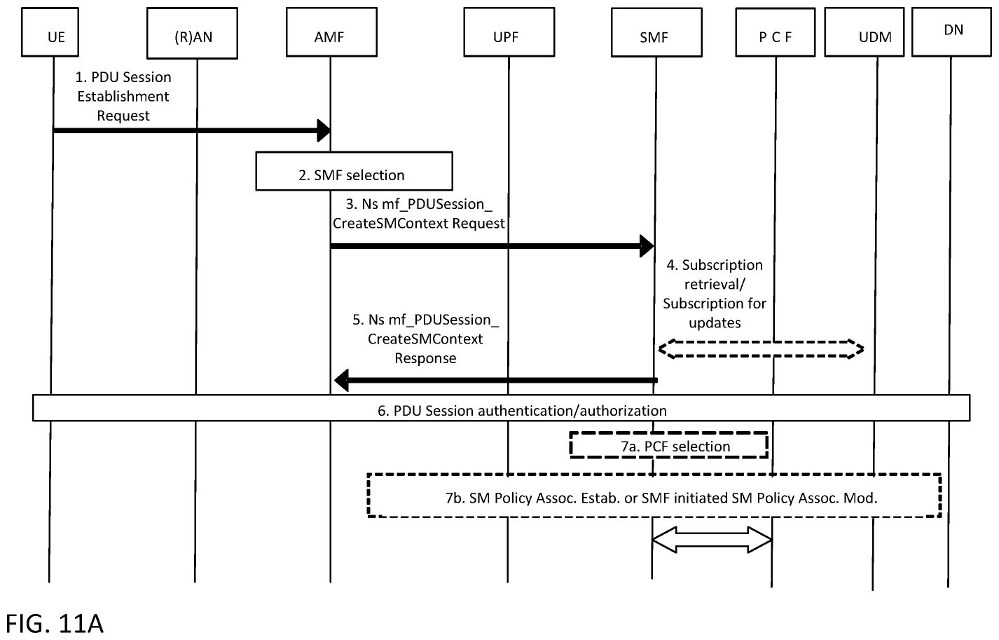

A UE may establish multiple PDU sessions to the same data network or to different data networks, via 3GPP and non-3GPP access networks at the same time. A UE may establish multiple PDU sessions to the same data network (DN) and served by different UPF terminating N6. A UE with multiple established PDU sessions may be served by different SMFs. The SMF serving a PDU session (e.g. the anchor) does not change during the lifetime of the PDU session. FIG. 10 illustrates the protocol stack for the user plane transport associated with a PDU session.

A 3GPP 5G network may support several session and service continuity (SSC) modes-SSC mode 1, SSC mode 2, and SSC mode 3. With SSC mode 1, the network preserves the connectivity service provided to the UE. For the case of a PDU session of the IPV4 or IPV6 or IPv4v6 type, the IP address is preserved. The UPF acting as a PDU session anchor at the establishment of the PDU session is maintained regardless of the access technology (e.g., access type and cells) a UE is successively using to access the network. In the case of a PDU session of the IPV4 or IPV6 or IPv4v6 type, IP continuity is supported regardless of UE mobility events. SSC mode 1 may apply to any PDU session type and to any access type.

With SSC mode 2, the network may release the connectivity service delivered to the UE and release the corresponding PDU session(s). For the case of the IPV4 or IPV6 or IPV4v6 type, the release of the PDU session induces the release of IP address(es) that had been allocated to the UE. If a PDU session of SSC mode 2 has a single PDU session anchor, the network may trigger the release of the PDU session and instruct the UE to establish a new PDU session to the same data network immediately.

The trigger condition depends on operator policy, for example, a request from an application function (AF), based on load status, etc. At establishment of the new PDU session, a new UPF acting as PDU session anchor can be selected. Otherwise, if a PDU session of SSC mode 2 has multiple PDU session anchors (e.g., in the case of multi-homed PDU sessions or in the case that UL CL applies to a PDU session of SSC mode 2), the additional PDU session anchors may be released or allocated. SSC mode 2 may apply to any PDU session type and to any access type.

With SSC mode 3, a connection through a new PDU session anchor point is established before the previous connection is terminated in order to allow for better service continuity. For the case of IPV4 or IPV6 or IPv4v6 type, the IP address is not preserved in this mode when the PDU session anchor changes.

For PDU session of SSC mode 3, the network allows the establishment of UE connectivity via a new PDU session anchor to the same data network before connectivity between the UE and the previous PDU session anchor is released. When trigger conditions apply, the network decides whether to select a PDU session anchor UPF suitable for the UE's new conditions (e.g., point of attachment to the network).

In Release 16, SSC mode 3 only applies to the IP PDU session type and to any access type. After the new IP address/prefix has been allocated, the old IP address/prefix is maintained during some time indicated to the UE via NAS signaling or via Router Advertisement and then released. If a PDU session of SSC mode 3 has multiple PDU session anchors, the additional PDU session anchors may be released or allocated.

Application layer context is information that is stored in the UE and used by a UE application to communicate with a network server. Application layer context is also stored in the network servers that host network applications that communicate with the UE applications.

UE application context includes IP addresses, port numbers, security credentials, user identities, and applications identifiers.

A data network name (DNN) in a 5G system is equivalent to an access point name (APN) in LTE. See 3GPP TS 23.501, System architecture for the 5G System (5GS); Stage 2. Both identifiers have an equivalent meaning between their respective systems and carry similar information.

A DNN may be used, e.g., to:
First, select an SMF and UPF(s) for a PDU session.
Second, select N6 interface(s) for a PDU session.
Third, determine policies to apply to this PDU session.

A wildcard DNN is a value that can be used for the DNN field of subscribed DNN list of session management subscription data defined in clause 5.2.3.3 of TS 23.502. The wildcard DNN can be used with an S-NSSAI for the operator to allow the subscriber to access any data network supported within the network slice associated with the S-NSSAI.

The 5GC supports a PDU connectivity service. The PDU connectivity service is supported via PDU sessions that are established upon request from the UE. The subscription information for each S-NSSAI may contain a subscribed DNN list and one default DNN. When the UE does not provide a DNN in a NAS message containing PDU session establishment request for a given S-NSSAI, the serving AMF determines the DNN for the requested PDU session by selecting the default DNN for this S-NSSAI if a default DNN is present in the UE's Subscription Information; otherwise, the serving AMF selects a locally configured DNN for this S-NSSAI.

The expectation is that the URSP in the UE is always up to date using the procedure defined in TS 23.502 clause 4.16.12.2 and therefore the UE requested DNN will be up to date.

In order to cover cases that UE operates using local configuration, but also other cases where operator policies can be used in order to replace an “up to date” UE requested DNN with another DNN used only internally in the network, during a UE registration procedure the PCF may indicate, to the AMF, the operator policies to be used at PDU session Establishment for DNN replacement of a UE requested DNN. PCF may indicate a policy for DNN replacement of UE requested DNNs not supported by the network, and/or indicate a list of UE requested DNNs per S-NSSAI valid for the serving network, which are subject for replacement (details are described in TS 23.503).

If the DNN provided by the UE is not supported by the network and AMF cannot select an SMF by querying NRF, the AMF shall reject the NAS Message containing PDU session establishment request from the UE with a cause indicating that the DNN is not supported unless the PCF provided the policy to perform a DNN replacement of unsupported DNNs.

If the DNN requested by the UE is indicated for replacement or the DNN provided by the UE is not supported by the network and the PCF provided the policy to perform DNN replacement of UE requested DNNs not supported by the network, the AMF shall interact with the PCF to perform a DNN replacement. During PDU session Establishment procedure and as a result of DNN replacement, the PCF provides a list of selected DNN for replacement that is applicable for the S-NSSAI requested by the UE at the PDU session Establishment. The AMF uses the selected DNN in the query towards the NRF for the SMF selection and provides both requested and selected DNN to the selected SMF. Note that interaction between the AMF and PCF is required when DNN Replacement is performed in the network.

AMF selection is a procedure that is performed by the 5G-AN (e.g. the base station). The procedure is used to select an AMF instance to serve a UE. AMF selection is also a procedure that can be performed by the AMF. An AMF may perform the procedure to select another AMF to serve a UE when it determines that it is not an appropriate AMF to server the UE. For example, this may happen if the UE attempts to register to a different network slice.

When the 5G-AN performs AMF selection, the 5G-AN considers what slices the UE has requested and other information such as local operator policies, the UE's properties (e.g., RAT type), etc.

The AMF allocates a 5G Globally Unique Temporary Identifier (5G-GUTI) to the UE that is common to both 3GPP and non-3GPP access. It is possible to use the same 5G-GUTI for accessing 3GPP access and non-3GPP access security context within the AMF for the given UE. An AMF may re-assign a new 5G-GUTI to the UE at any time.

The 5G-GUTI is structured as:

<5G-GUTI>:=<GUAMI><5G-TMSI>
where GUAMI identifies one or more AMF(s).

The Globally Unique AMF ID (GUAMI) is structured as:

<GUAMI>:=<MCC><MNC><AMF Region ID><AMF Set ID><AMF Pointer>

The 5G-S-TMSI is the shortened form of the GUTI to enable more efficient radio signaling procedures (e.g., during Paging and Service Request) and is defined as:

<5G-S-TMSI>:=<AMF Set ID><AMF Pointer><5G-TMSI>

The UE Route Selection Policy (URSP) includes a prioritized list of URSP rules. See 3GPP TS 23.503, Policy and charging control framework for the 5G System (5GS); Stage 2, and Table 2 below. The structure of the URSP rules is described in Table 3 and Table 4 below.

A route selection descriptor (RSD) contains one or more of the following components:
Session and Service Continuity (SSC) Mode: Indicates that the matching application's traffic shall route via a PDU session supporting the included SSC Mode.
Network Slice Selection: Indicates that the traffic of the matching application shall be routed via a PDU session supporting any of the included S-NSSAIs.
DNN Selection: Indicates that the traffic of the matching application shall be routed via a PDU session supporting any of the included DNNs. When DNN is used in Traffic descriptor, corresponding RSD of the rule shall not include DNN Selection component.
PDU session Type Selection: Indicates that the traffic of matching application shall be routed via a PDU session supporting the included PDU session Type.
Non-Seamless Offload indication: Indicates that traffic of the matching application is to be offloaded to non-3GPP access outside of a PDU session when the rule is applied. If this component is present in an RSD, no other components shall be included in the RSD.
Access Type Preference: If the UE needs to establish a PDU session when the rule is applied, this indicates the Access Type (3GPP or non-3GPP).

One URSP rule with the “match all” traffic descriptor is used to route the traffic of applications which do not match any other URSP rules and shall be evaluated with the lowest priority in rule precedence. The RSD in this URSP rule includes at most one value for each Route Selection Component. However, note that TS 23.503 states “If the UE fails to establish a PDU session with any of the route selection descriptors, it tries other URSP rules in the order of rule precedences with matching Traffic descriptors, except the URSP rule with the “match-all” Traffic descriptor, if any. The UE shall not use the UE Local Configuration in this case.”.

Route Selection Validation Criteria or simply Validation Criteria is defined in TS 23.503. Route Selection Validation Criteria consists of a list of attributes whose configured values must be met for the RSD in URSP to be valid. Table 4 shows a list of Route Selection Validation Criteria that includes time window and location criteria.

With respect to the time window, the route selection descriptor is not to be considered valid unless the UE is in the time window. With location criteria, the route selection descriptor is not be considered valid unless the UE's location matches the location criteria.

In addition, when the route selection descriptor includes a time window or a location criteria, the PDU session is considered matching only if the PDU session is associated with the same time window or a location criteria validity conditions. However, a UE's support of the Validation Criteria in a URSP rule is optional. If a non-supporting UE receives Validation Criteria, it ignores the Validation Criteria portion of the RSD and uses the rest of RSD.

A UE may be provisioned with URSP rules by the PCF of the HPLMN. When the UE is roaming, the PCF in the HPLMN may update the URSP rule in the UE. In addition, the UE may also be pre-configured with URSP rules (e.g., by the operator). If both URSP rules provisioned by the PCF and pre-configured URSP rules are present, only the URSP rules provisioned by the PCF is used by the UE.

For every newly detected application the UE evaluates the URSP rules in the order of rule precedence and determines if the application matches the Traffic descriptor of any URSP rule. When a URSP rule is determined to be applicable for a given application, the UE shall select an RSD within this URSP rule in the order of the route selection descriptor Precedence Information name.

When a valid RSD is found, the UE determines if there is an existing PDU session that matches all components in the selected RSD. When a matching PDU session exists, the UE associates the application to the existing PDU session, e.g. route the traffic of the detected application on this PDU session. If none of the existing PDU sessions matches, the UE tries to establish a new PDU session using the values specified by the selected RSD. If the PDU session establishment request is accepted, the UE associates the application to this new PDU session.

The RSD of a URSP rule is considered valid if the following conditions are met:
If any S-NSSAI(s) is present, the S-NSSAI(s) is in the Allowed NSSAI; and
If any DNN is present and the DNN is an LADN DNN, the UE is the area of availability of this LADN.

The V-PCF may retrieve ANDSP and URSP from the H-PCF via N24/Npcf.

When the UE is roaming, and the UE has valid rules from both HPLMN and VPLMN the UE gives priority to the valid ANDSP rules from the VPLMN.

URSP rules are used to associate application traffic with an existing, or new PDU session. For the case that an application cannot be associated to any PDU session, the UE can inform the application that association of the application to PDU session failed. Note that the UE may periodically check if PDU sessions are being used. If they are not being used, the UE may initiate a PDU session Release.

For every new application flow that needs to be established, the UE evaluates URSP rules in the order of rule precedence, then the UE either triggers a PDU session establishment or uses an existing PDU session for the flow. The location attribute is a URSP rule constraint that needs to be valid for the URSP rule to be applicable. That is, when the route selection descriptor includes a time window or a location criteria, the traffic flow is considered matching only if the UE's location matches the location criteria validity conditions. In addition, TS 23.503 describes that the UE (re-) evaluates the validities of URSP rules in a timely manner when certain conditions are met, for example, the URSP is updated by the PCF when:
the UE moves from EPC to 5GC;
change of Allowed NSSAI or Configured NSSAI;
change of LADN DNN availability;
UE registers over 3GPP or non-3GPP access;
UE establishes connection to a WLAN access.

According to 3GPP TS 24.526, User Equipment (UE) policies for 5G System (5GS); Stage 3, the UE may re-evaluate the URSP rules to check if the change of the association of an application to a PDU session is needed, when:
the UE performs periodic URSP rules re-evaluation based on UE implementation;
the UE NAS layer indicates that an existing PDU session used for routing traffic of an application based on a URSP rule is released;
the URSP is updated by the PCF;
the UE NAS layer indicates that the UE performs inter-system change from S1 mode to N1 mode;
the UE NAS layer indicates that the UE is successfully registered in N1 mode over 3GPP access or non-3GPP access;
the UE establishes or releases a connection to a WLAN access and transmission of a PDU of the application via non-3GPP access outside of a PDU session becomes available/unavailable;
the allowed NSSAI is changed; or
the LADN information is changed.

If the re-evaluation leads to a change of the association of an application to a PDU session, the UE may enforce such change immediately or when UE returns to 5GMM-IDLE mode. The URSP handling layer may request the UE NAS layer to release an existing PDU session after the re-evaluation.

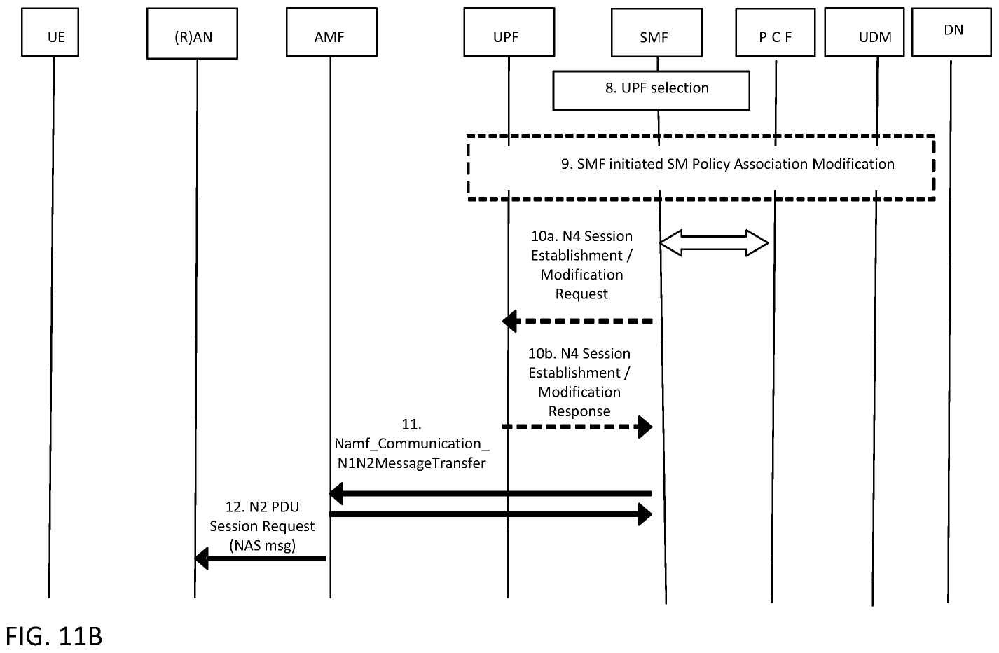

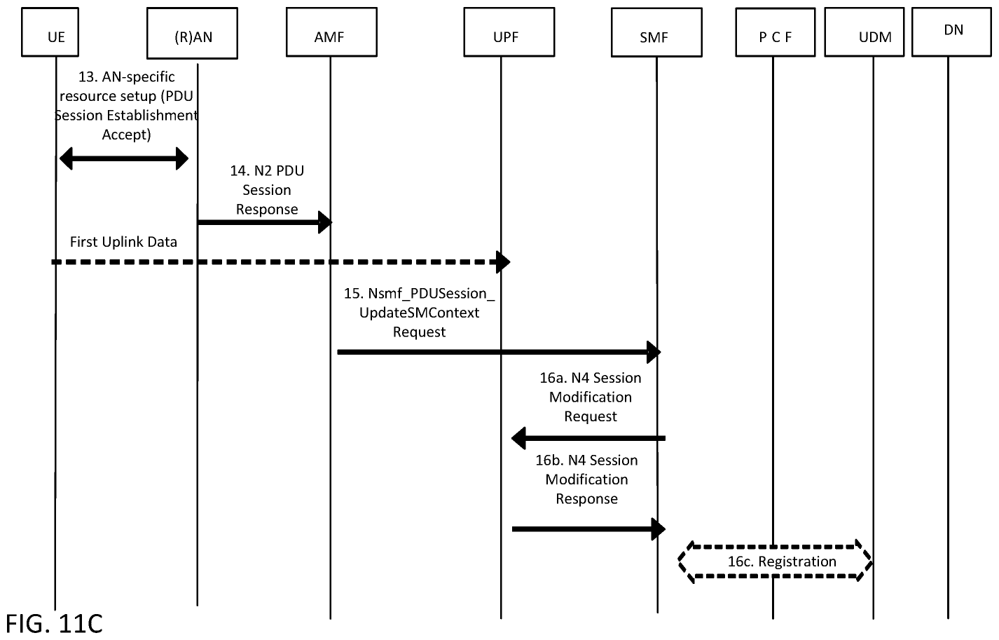

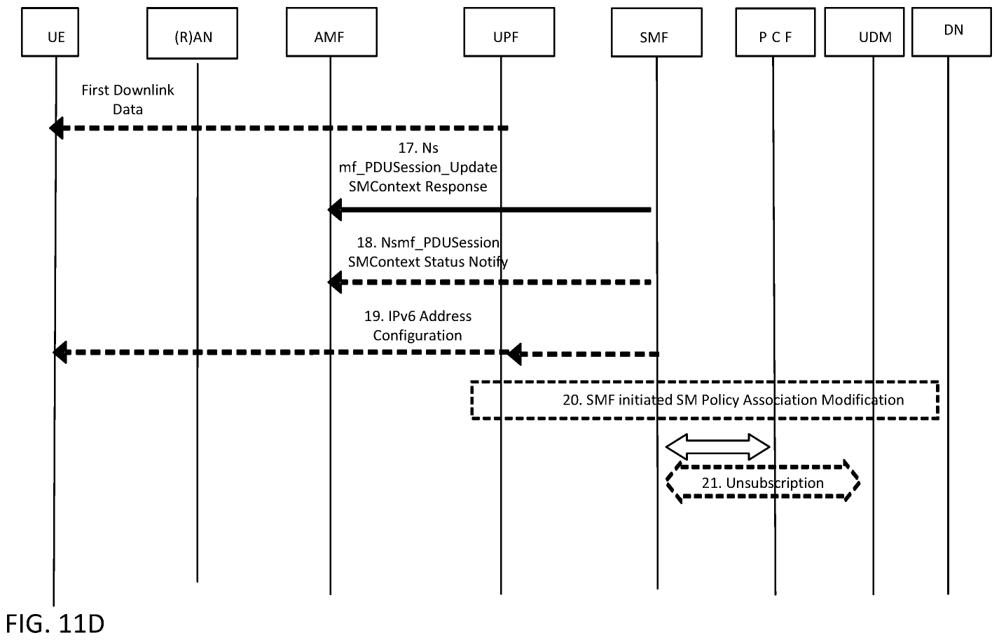

FIGS. 11A-11D are copied from 3GPP TS 23.502 which shows the PDU session establishment process in the non-roaming and roaming with local breakout cases. The procedure is used by a UE to establish a new PDU session.

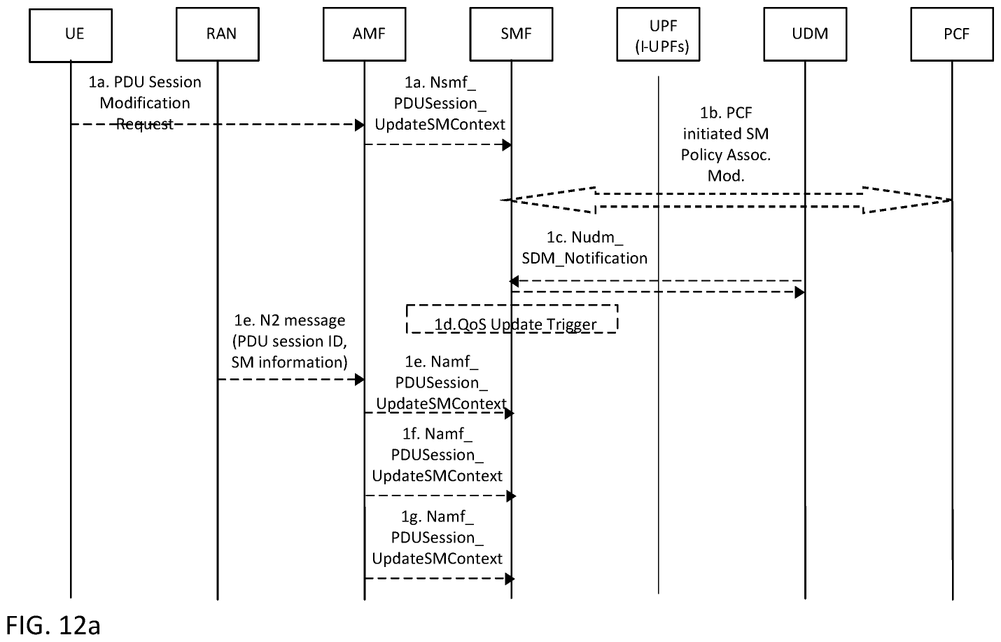

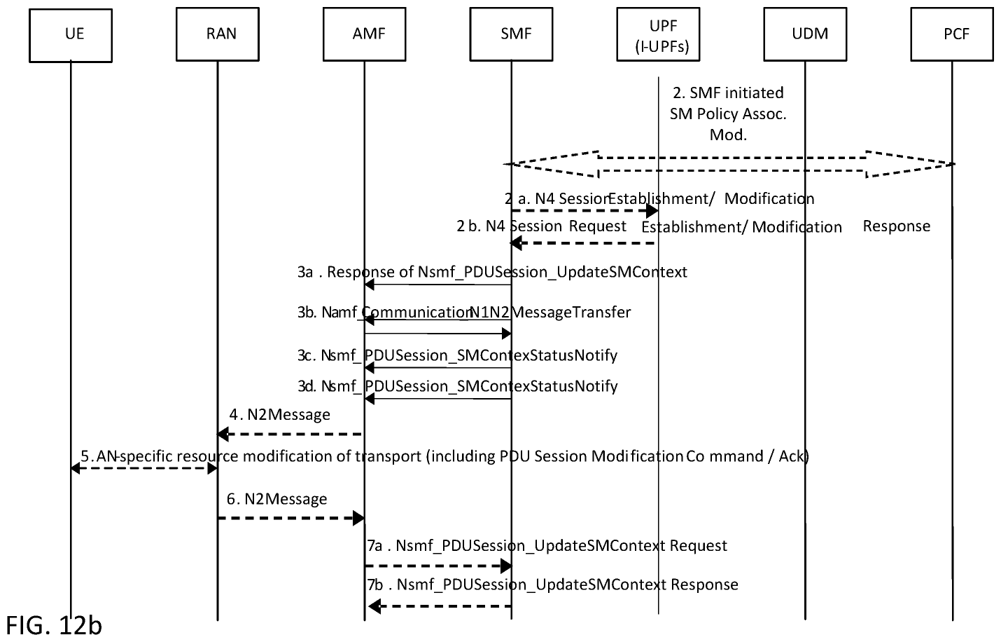

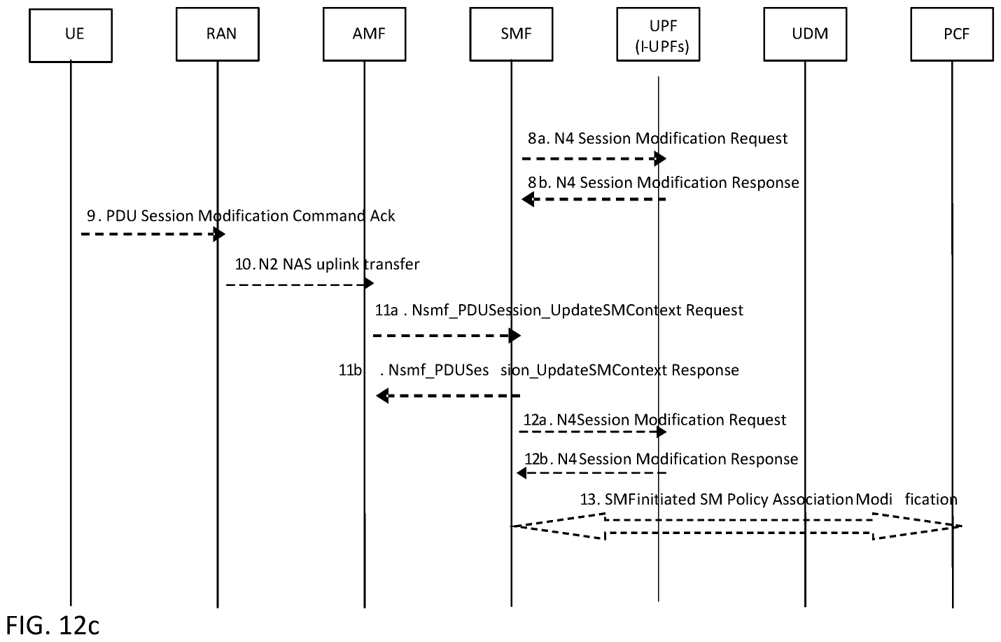

The UE or network requested PDU session modification procedure (non-roaming and roaming with local breakout scenario) is depicted in FIGS. 12a-c. FIGS. 12a-c are copied from 3GPP TS 23.502. The procedure is used by a UE or by the network to modify a PDU session.

The term UE may refer to a mobile phone, mobile computer, mobile broadband adaptor, connected vehicle, connected device, etc. that can connect to a cellular network. The UE may have an MT (Mobile Termination) part which provides a cellular radio interface and a TE (Terminal Equipment) part that offers services to a user and does not typically provide features that are specific to the cellular radio interface part. For example, the TE might provide a control GUI. The TE and MT parts of the UE may communicate via AT Commands. Some examples of AT Commands are defined in 3GPP TS 27.007.

A UE may also have a SIM that stores user credentials and network identities. It should be appreciated that the ideas in this paper equally apply to devices that do not have a SIM to store user credentials and network identities. Devices can instead store user credentials and network identities in other forms of non-volatile memory. Thus, all ideas in this paper that are described as applying to a UE, could equally apply to any device.

There are events that require 5G mobility management (MM) context deletion, but also cause 5G session management (SM) context deletion (and therefore application layer). For example, when there is an OS update, a modem reset, or a network-initiated deregistration request with “Re-registration Required,” the UE's 5G MM context must be cleared. However, these events will also cause the 5G SM context and application layer information to be deleted. There are also situations where the UE will need to de-register from the network and re-register with the network.

In a first example, when the UE is connected to the network for emergency services and the upper layers indicate that emergency services are no longer required, the UE may perform a UE-initiated de-registration procedure followed by a re-registration to regain normal services. The UE-initiated deregistration procedure is described in clause 4.2.2.3.2 of 3GPP TS 23.502.

In a second example, the network (e.g. the AMF) may send a de-registration request to the UE with a re-registration required notification. The AMF may be triggered to send this message by the O&M system. Although the purpose of the O&M request may be only to force the UE to register to a new AMF or to reset the UE's MM context, the current 5G system design requires that both MM and SM context are deleted when a de-registration procedure is executed. The network-initiated deregistration procedure is described in clause 4.2.2.3.3 of TS 23.502.

In a third example, the network (e.g. the AMF) may initiate a network-initiated deregistration if it detects that the UE's registered PLMN is not allowed to operate in the present UE location. In this case, the AMF will include in a deregistration request the country in which the UE is located. Note that this de-registration procedure will cause the UE's SM context to be deleted. However, the SM context may be anchored to H-SMF instances that are allowed to operate in the UE's current location. The network-initiated deregistration procedure is described in clause 4.2.2.3.3 of TS 23.502.

In the three examples listed above, although deletion and re-creation of NAS-MM context may be sufficient, NAS-SM context will also be deleted. Deletion of NAS-SM context, which includes the UE's IP address(es), will often result in the deletion of at least some application layer context. For example, in the three examples listed above, the change in IP address will typically cause UE hosted applications to re-establish application layer connections and re-create, or update, application layer context. Of course, re-establishment or re-creation of application layer context would only occur after the UE re-establishes PDU session and new NAS-SM context is created.

5G system enhancements described herein may allow the UE and network to delete NAS-MM context without deleting NAS-SM context. Specifically, the network may be able to identify if the UE is capable of preserving NAS-SM context during a NAS-MM reset; the network and UE may be able to identify which pieces of NAS-SM context need to be preserved during a NAS-MM reset; the network and UE may be able to initiate a NAS-MM reset procedure such that identified pieces of NAS-SM context are preserved during a NAS-MM reset; the network and UE may be able to store NAS-SM context during a NAS-MM reset; the network and UE may be able to initiate a NAS-SM context recovery and NAS-MM context creation; and the UE may be able to notify UE hosted applications that NAS-SM context and connectivity have been restored so that UE hosted applications may notify network applications servers that connectivity has been restored.

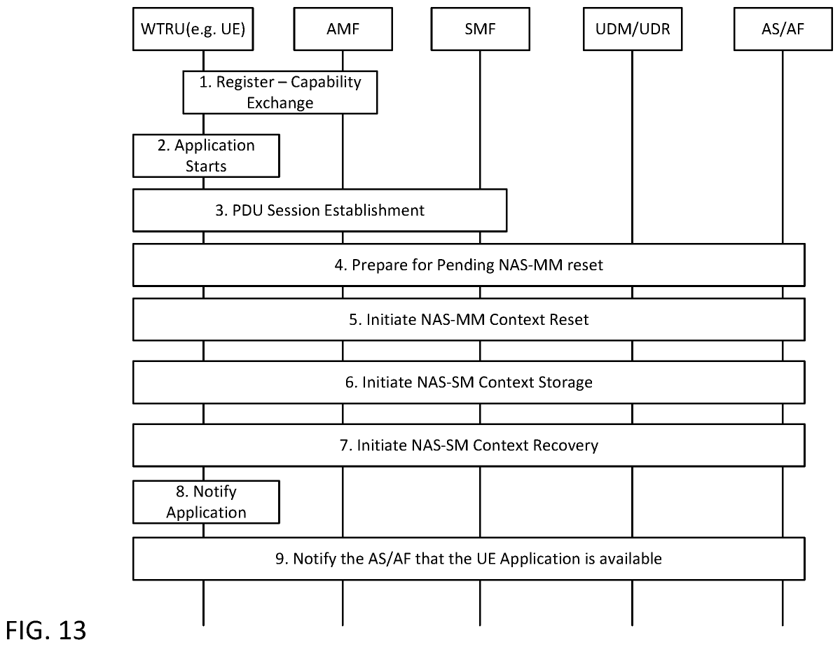

Described herein are methods, apparatus, and systems for preserving and re-establishing or recovering 5G SM context, and therefore application layer context, when an event triggers deletion and re-establishment of 5G MM context. FIG. 13 shows an example method for preserving and re-establishing or recovering 5G SM context. The method of FIG. 13 may enable a WTRU, such as a UE, and network to execute a NAS-MM reset without executing a NAS-SM reset.

In step 1, a WTRU, such as a UE, may perform an initial registration with the network. For example, the WTRU may send to a network node, a registration request message requesting to register with the network. The registration request message may comprise an indication that the WTRU is capable of preserving, when the WTRU becomes unavailable to the network, context information associated with the communications between the WTRU and the network. For example, the WTRU (e.g., UE) may indicate to the network that it is capable of preserving NAS-SM context while executing a NAS-MM reset. As further described below, the WTRU may send this information to the network so that the network is aware that the network may initiate a NAS-MM reset procedure such that NAS-SM context is preserved in the WTRU and network. The WTRU may also send this information to the network so that the network is aware that it is advantageous to select SMFs to serve the WTRU that are capable of preserving the WTRU's NAS-SM context when there is a NAS-MM reset.

The WTRU may receive, from the network node, a registration accept message. The registration accept message may comprise an indication that the network supports the preservation of context information when the WTRU becomes unavailable to the network.

In step 2, a WTRU hosted application may start. As described below, the WTRU hosted application may indicate to the network that it would like to receive a notification, or warning, when WTRU connectivity is about to be interrupted. Note that WTRU connectivity will be interrupted when there is a NAS-MM reset.

In step 3, the WTRU may determine to establish a PDU session for application traffic. The WTRU may employ the procedure illustrated in FIGS. 11A-D to request establishment of a PDU session. The WTRU may indicate to the network, in the PDU session establishment procedure, that NAS-SM context for the PDU session should be preserved when there is a NAS-SM context reset. For example, the WTRU may send (e.g., in step 1 of FIG. 11A), to the network, a request to establish a PDU session. The request to establish the PDU session comprises an indication that the context information for the PDU session is requested to be preserved when the WTRU becomes unavailable.

In step 4, as described more fully below, the WTRU may send to the network, based on a determination that the WTRU will become unavailable to the network, a message indicating a request to preserve context information. The message may comprise an indication of a time period during which the WTRU will be unavailable. For example, the WTRU may notify the AMF that a NAS-MM context reset is desired, or the AMF may notify the WTRU that a NAS-MM context reset is desired. As described more fully below, such notification or indication may be made as part of an N1-reset request message or a UE-initiated deregistration request message. The WTRU may prepare for the NAS-MM context reset by notifying WTRU host applications of the pending NAS-MM reset. The AMF may prepare for the NAS-MM context reset by informing the SMF of the pending NAS-SM reset. This is further described below.

In step 5, the WTRU or network may initiate a NAS-MM reset. Four examples of how a NAS-MM reset may be initiated are described below. In a first example, the WTRU may initiate a NAS-MM reset by initiating a WTRU (e.g., UE)-initiated deregistration procedure. In a second example, the AMF may initiate a NAS-MM reset by initiating a network-initiated deregistration procedure. In a third example, the WTRU may initiate a NAS-MM reset by initiating a new N1-reset procedure. In a fourth example, the AMF may initiate a NAS-MM reset with a new N1-reset procedure.

In step 6, NAS-SM context may be stored in the WTRU (e.g., UE), SMF, PCF, UPF, and/or UDM/UDR. This is further described below. As described earlier, SM context is listed in Table 6.1.6.2.39-1 of TS 29.502. The SM context may comprise the PDU session ID, the DNN, S-NSSAI, and IP address. The information in the SM context is associated with a PDU session.

In step 7, after the time period during which the WTRU was unavailable, the WTRU may send a message to the network indicating that the WTRU is again available to the network. For example, the WTRU may initiate NAS-SM context recovery, and creation of new NAS-MM context, by sending a second registration request to the network.

In step 8, as described below, the WTRU may notify the WTRU hosted application that connectivity has been restored. In other words, the WTRU hosted application may be notified when new NAS-MM context has been created and the NAS-SM context that is associated with the WTRU hosted application has been restored.

In step 9, as described below, the WTRU hosted application may notify an AS/AF that the WTRU hosted application's connectivity and its NAS-SM context have been restored.

When a WTRU (e.g., UE) sends a NAS-MM registration message to the network, the message is carried in an RRC message to the NG-RAN node. The NG-RAN node will select an AMF and send the NAS-MM registration message to the AMF. The UE may include an indication in the RRC part of the message to indicate to the NG-RAN node that the UE supports and may use a feature that allows the UE's NAS-MM context to be reset/deleted in the UE and network while the UE's NAS-SM context is maintained in the UE and the network. This feature may be referred to herein as the “persistent NAS-SM context” feature, and the indication may be referred to herein as a “persistent NAS-SM context supported indication.” The persistent NAS-SM context supported indication may be used by the NG-RAN node to determine that the NG-RAN should select an AMF that supports the persistent NAS-SM context feature.

The UE may further include a persistent NAS-SM context supported indication in the NAS-MM registration message. This persistent NAS-SM context supported indication in the NAS-MM registration message may indicate to the AMF that the UE supports the persistent NAS-SM context feature, and that the UE may desire to the use the feature. The AMF may use this information when performing SMF selection in order to ensure that the AMF selects an SMF that supports the feature. The AMF may send a registration accept message to the UE. The registration accept message may include an indication that the AMF supports the persistent NAS-SM context feature, and that the UE may attempt to use the feature.

The AMF sends the registration accept message to the NG-RAN node and the NG-RAN node forwards the message to the UE in an RRC message. The NG-RAN may include, in the RRC part of the message, an indication of whether the NG-RAN node selected an AMF that supports the persistent NAS-SM context feature.

The UE may host critical applications whose functionality and/or reliability depend on the UE's SM context being preserved during a NAS-MM reset. Thus, the UE may only desire to connect to networks that support the NAS-SM context preservation feature. The NG-RAN may broadcast an indication in System Information that indicates to the UE that the NG-RAN node is capable of selecting an AMF that supports the NAS-SM context feature.

In scenarios where the UE registers to the network via non-3GPP access, the UE may send the persistent NAS-SM context supported indication to the TWAP, TNGF, or N3IWF so that the TWAP, TNGF, or N3IWF can consider the indication during AMF selection.

As discussed earlier, the persistent NAS-SM context supported indication may be sent to the AMF in the NAS-MM registration request message. If the AMF determines that it cannot support the feature, but a different AMF can support the feature, the AMF may perform an AMF selection procedure with the NRF, provide the indication to the NRF, and determine a new AMF to serve the UE.

The UE may provide separate persistent NAS-SM context supported indications to the AMF for each S-NSSAI in the Requested S-NSSAI. In other words, the UE may indicate whether it desires to use the feature for each slice that it requests on a per slice basis.

The UE may receive configuration information from the AMF in the registration response that indicates whether the persistent NAS-SM context feature is supported for each slice of the Allowed NSSAI.

Alternatively, the UE may store configuration for each slice of the Configured NSSAI. The configuration information may include an indication of whether each slice supports the persistent NAS-SM context feature. The UE may receive persistent NAS-SM context supported indication for each slice of the Configured NSSAI when it receives the Configured NSSAI in a registration accept or configuration update message.

An application on the UE may require, or prefer, that its SM context be preserved when the UE's MM context is reset. For example, the application may require, or prefer, that its IP address be preserved when the UE's MM context is reset.

When an application generates uplink traffic, URSP rules may be used to determine that the application traffic should use a PDU session whose SM context will be preserved when the UE's MM context is reset. For example, the RSD part of a URSP rule may include a select persistent NAS-SM context indication. The presence of indication in the RSD may serve as an indication to the UE that the associated traffic should be associated with a PDU session whose SM context will be preserved when the UE's MM context is reset.

Alternatively, the application may provide the activate NAS-SM context preservation indication to the ME part of the UE as part of the traffic descriptor. When the activate NAS-SM context preservation indication is part of the traffic descriptor, the UE may only select an existing PDU session for the traffic if the feature is enabled for the PDU session, otherwise, the UE will attempt to establish a new PDU session for the traffic and will attempt to enable the feature for the new PDU session.

If the application provides the activate NAS-SM context preservation indication to the ME part of the UE as part of the traffic descriptor, the indication may be sent to the ME by the TE via an AT Command. For example, the indication may be provided when the +CGDCONT AT Command is used. The +CGDCONT AT Command, which is defined in 3GPP TS 24.007, AT command set for User Equipment (UE), is used to specify PDU session parameters.

The UE may determine that no existing PDU sessions support the needs of the application traffic. The UE will then send a PDU session establishment request to the AMF. The PDU session establishment request will include the activate NAS-SM context preservation indication. The activate NAS-SM context preservation indication may be included in the NAS-MM part of the message so that the AMF can use the activate NAS-SM context preservation indication during SMF selection, thus ensuring that the AMF will select an SMF that supports the feature. The activate NAS-SM context preservation indication may also be part of the N1 SM container (e.g. the NAS-SM part of the message) so that the SMF knows that the feature should be enabled for the PDU session.

Alternatively, the system may be designed such that certain SMF's only serve PDU sessions whose context needs to be preserved during an NAS-MM reset. In this scenario, the activate NAS-SM context preservation indication would not need to be included in the NAS-SM part of the PDU session establishment request message.

Alternatively, as described earlier, the UE may have been configured with a persistent NAS-SM context supported indication for the S-NSSAI that is associated with the PDU establishment request. The persistent NAS-SM context supported indication may be interpreted by the UE as an indication that the feature may be enabled for PDU sessions of the slice, or the indication may be interpreted by the UE as an indication that the feature is associated with all PDU sessions of the slice. If the indication is interpreted by the UE as an indication that the feature is associated with all PDU sessions of the slice, then the UE does not need to provide the indication during PDU session establishment; the UE and network functions would understand that the feature is enabled for the PDU session because the indication is included in the configuration information that is associated with the slice.

The PDU session establishment accept message may indicate to the UE whether the feature is enabled for the PDU session. For example, the SMF may include a NAS-SM context preservation enabled indication in the PDU session establishment accept message that is sent to the UE and the UE may maintain a list of PDU sessions in which NAS-SM context is configured for preservation during NAS-MM reset events. The SMF may also include a NAS-SM context preservation timer to indicate to the UE how long the NAS-SM context will be preserved for after the NAS-MM reset event.

The SMF may also send the NAS-SM context preservation enabled indication to the AMF when the SMF invokes the Namf_Communication_NIN2MessageTransfer service operation. The reason for sending the NAS-SM context preservation enabled indication to the AMF is that it will serve as a notification to the AMF that the UE has PDU sessions whose NAS-SM context needs to be maintained during a NAS-MM reset and that it is possible to reset the UE's NAS-MM context without resetting the UE's NAS-SM context. As a result of this notification, the AMF may save in the UE context that the AMF maintains for the UE which PDU sessions are configured for NAS-SM context preservation for when a NAS-MM reset event occurs. In turn, the UE would not need to specify the PDU sessions whose NAS-SM context should be preserved during deregistration. In addition to the NAS-SM context preservation enabled indicator, the SMF may also provide a timer value for how long the NAS-SM context should be preserved. The timer value may be sent to both the AMF and the UE.

The NAS-SM context preservation enabled indication may be sent to the ME by the TE via an AT Command. For example, the indication may be provided when the +CGDCONT-? AT Command is used. The +CGDCONT=? AT Command, which is defined in TS 27.007, is used to check, or read, PDU session parameters.

The persistent NAS-SM context feature may be considered an extension, or improvement, of SSC Mode 1. When SSC Mode 1 is used, the UE's IP address is preserved regardless of UE mobility events. When the persistent NAS-SM context feature is enabled, the UE's SM context, which includes the UE's IP address is preserved even when there is a NAS-MM reset.

A 4th SSC Mode may be considered. SSC Mode 4 may also be characterized by the fact that the UE's IP address is preserved regardless of UE mobility events. However, SSC Mode 4 may also be characterized by the fact that the SM context that is associated with the PDU session may be preserved during a NAS-MM reset, whereas the SM context that is associated with a PDU session of SSC Mode 1 is not preserved during a NAS-MM reset.

When the persistent NAS-SM context feature is associated with SSC Mode 4, the UE may send the activate NAS-SM context preservation indication to the network by setting the requested SSC mode in the PDU session establishment request to 4 and the network may send the NAS-SM context preservation enabled indication to the UE by setting the allowed SSC mode to 4 in the PDU session establishment accept message. Table 5 below shows an example of how the SSC Mode 4 may be encoded and thus indicate to the network that the activate NAS-SM context preservation indication should be enabled.

It may also be desirable to use the persistent NAS-SM context feature with SSC Modes 1 and 2. Although the use of SSC Modes 2 and 3 imply that the UE applications that use the PDU session do not require the IP Address to be preserved, enabling the persistent NAS-SM context feature may still be advantageous. Using the persistent NAS-SM context feature with any SSC Mode may still be advantageous because using the feature allows the UE and network to reduce the amount of interaction that is required between the UE and network to reestablish PDU sessions. Table 6 below shows an example of how the SSC Mode encoding may be enhanced to also indicate if the UE requests that the feature be enabled and indicate if the network has enabled the feature.

A UE may have established PDU sessions with the persistent NAS-SM context feature enabled. An event may occur at the UE and the UE may determine that the event requires the UE to reset its NAS-MM context. Resetting the NAS-MM context may be initiated by sending a deregistration request to the network. However, when the UE may determine that the NAS-SM context may be preserved while the UE is in the RM-DEREGISTERED state. The UE may indicate to the network in the deregistration request that the NAS-SM context should be preserved while the UE is in the RM-DEREGISTERED state. The AMF may then notify the SMF(s) that are associated with the PDU sessions whose context needs to be preserved and help the SMF to coordinate preservations timers between the UE and SMF. The UE-initiated deregistration procedure is shown in FIG. 8 and may be enhanced as follows.

The deregistration request of step 1 may be enhanced such that the UE may indicate to the AMF that the UE's NAS-SM context should be preserved while the UE is in the RM-DEREGISTERED state. The request may identify which PDU sessions' NAS-SM context needs to be preserved by including the PDU session ID of each PDU session whose NAS-SM context needs to be preserved. For each PDU session whose contexts need to be preserved, the UE may include an N1 SM container. The N1 SM container may include an indication that the UE desires that NAS-SM context be maintained and a time value that indicates how long the UE requests that the SMF preserve the UE's NAS-SM context. The current 5G System design does not allow the UE to indicate to the network that the deregistration type is “re-registration required”. The deregistration request of step 1 may be further enhanced to allow the UE to indicate to the network that the deregistration type is “re-registration required”. The advantage of this allowing the UE to indicate to the network that re-registration is required is that it would allow the UE to indicate to the network that the UE plan on re-registering, for example, in cases where the UE only needs to perform a NAS-MM reset.

Alternatively or in addition, the UE deregistration request of step 1 may be enhanced such that the UE may indicate a mobility status, anticipated re-registration parameters (e.g., immediate vs. timed vs. event-based), anticipated re-registration cause (e.g., emergency services release, O&M request). The mobility status may be used by the network to determine whether the same UPF may serve the UE upon re-registration. Similarly, other predictive information may be included in the de-registration request which may be used by the network to determine how to configure the context storage and re-establishment parameters, buffering at the UPF, etc.

Alternatively or in addition, it might not be necessary to explicitly indicate to the AMF that the UE's NAS-SM context should be preserved while the UE is RM-DEREGISTERED. Rather, the AMF may assume that the UE's NAS-SM context should be preserved while the UE is RM-DEREGISTERED whenever the UE sets the deregistration type IE in the deregistration request to “re-registration required.” A disadvantage of this alternative would be that the NAS-SM context might end up being preserved in the network even when the UE desires that the NAS-SM context not be preserved.

Previously, it was described the AMF may update the UE context it maintains whenever a NAS-SM context preservation enabled indicator was provided by the SMF to the AMF in the Namf_Communication_NIN2MessageTransfer service operation of the PDU session establishment procedure. If the AMF maintains a list of PDU sessions in which NAS-SM context is to be preserved, then the UE may only need to perform a deregistration request to the AMF. In addition, the AMF may have also been provided with a timer value for how long to preserve the NAS-SM context for the UE and upon receiving the deregistration request from the UE, the AMF starts a timer. If the UE does not re-register before the expiration of the timer, the AMF then deletes the remaining NAS-SM context that have been preserved for the UE.

The invocation of Nsmf_PDUSession_ReleaseSMContext Request in step 2 may be enhanced so that the AMF sends both the SM context ID and an N1 SM container that the UE sent in step 1, to the SMF. The SMF may use the contents of the N1 SM container to recognize that the UE will be moving to the RM-DEREGISTED state and that NAS-SM context should be preserved. The N1 SM container may include a preservation expiration timer. Alternatively, step 2 may invoke Nsmf_PDUSession_UpdateSMContext which may allow establishment of forwarding tunnel between UPFs controlled by different SMFs. The procedure of FIG. 8 may be enhanced so that step 3 is skipped, or step 3 may be enhanced so that the SMF notifies the UPF that the UE will be moving to the RM-DEREGISTED state and that NAS-SM context should be preserved. The advantage of notifying the UPF that the UE will be moving to the RM-DEREGISTED state, and that NAS-SM context should be preserved is that the UPF would know to buffer, or discard, any DL packets that are received for the PDU session. The SMF may indicate to the UPF whether packets should be buffered or discarded.

The invocation of Nsmf_PDUSession_ReleaseSMContext Response in step 4 may be enhanced so that the SMF may provide a SM context storage ID and an SM context storage expiration timer to the AMF and an N1 SM container. The N1 SM container may also include the SM context storage ID and the SM context storage expiration time. The SM context storage ID is an identifier of the SM context. The SM context storage ID may identify a storage location where the SM context is stored. For example, the storage location may be associated with the SMF, a UDSF, or the UDM/UDR. The SM context storage expiration time may be stored with the SM context. The SMF may use the time value that the UE included in the N1 SM container to derive the SM context storage expiration time that will be sent to the UE an N1 SM container.

The procedure of FIG. 8 may be enhanced so that step 5a is skipped or step 5a may be enhanced so that the SMF notifies the PCF that the UE will be moving to the RM-DEREGISTED state and that NAS-SM context should be preserved.

The procedure of FIG. 8 may be enhanced so that step 5b-c is skipped, or step 5b-c may be enhanced so that, instead of unsubscribing from the UDM or indicating to the UDM that the UDM should remove the association it had stored between the SMF identity and the associated DNN and PDU session Id, the SMF will send the SM context to the UDM and request that the UDM store the SM context.

The procedure of FIG. 8 may be enhanced so that step 7 is enhanced so that the Deregistration Accept that is sent by the AMF to the UE includes the N1 SM container that was sent to the AMF by the SMF. The N1 container may indicate to the UE which parts of the NAS-SM context will be preserved (e.g., whether the UE's IP Address will be preserved during the NAS-MM reset, whether QoS rule for certain flows will be maintained, etc.). Multiple N1 SM containers may be sent to the UE (e.g. an N1 SM container may be sent to the UE for each PDU session, and the N1 SM containers may be sent by the SMFs that host the PDU sessions).

The UE may display a graphical user interface (GUI) that allows the user to initiate a NAS-MM reset. The GUI may further allow the user to select which UE applications need their context to be preserved during a NAS-MM reset. The UE may then determine that any PDU session(s) that are associated with the selected UE application(s) need to have their SM-context preserved during a NAS-MM reset and the UE may then include the PDU session IDs of the PDU sessions that are associated with the selected UE applications in the UE-initiated de-registration request.

An event may occur at the network and the network may determine that the event requires that the UE reset its NAS-MM context by sending a deregistration request to the UE, but that the NAS-SM context may be preserved while the UE is in the RM-DEREGISTERED state. The network may indicate to the UE in the deregistration request that the NAS-SM context should be preserved while the UE is in the RM-DEREGISTERED state and may further indicate how long the NAS-SM context will be preserved before the PDU session is re-established (e.g., a Register and Reestablish by Timer). The AMF may then notify the SMF(s) that are associated with the PDU sessions whose context needs to be preserved and help to coordinate preservations timers between the UE and SMF. The notification from the AMF may further indicate how long the NAS-SM context will be preserved before the PDU session is re-established (e.g. the Register and Reestablish by Timer). The network-initiated deregistration procedure is shown in FIG. 9 and may be enhanced as follows.

In step 2, an event may trigger the AMF to send a deregistration request to the UE. The deregistration request may be enhanced such that the AMF may indicate to the UE that the UE's NAS-SM context should be preserved while the UE is RM-DEREGISTERED. The request may identify which PDU session's NAS-SM contexts need to be preserved by including the PDU session ID of each PDU session whose NAS-SM context needs to be preserved. For each PDU session whose context needs to be preserved, the AMF may include an N1 SM container. The N1 SM container may include an indication that the network desires that NAS-SM context be maintained and a time value that indicates how long the UE should preserve the UE's NAS-SM context.

The deregistration request may also include a deregister-by timer. The deregister-by timer may indicate to the UE that the UE should deregister before the timer expires. The advantage of providing such a timer is that, compared to requesting that the UE immediately deregister, is that the ME part of the UE will be able to send a deregistration warning notification to applications that are hosted by the TE part of the ME. The applications that receive the warning would then be able to save their associated application layer context and send a warning to any application servers that they communicate with. The warning to the application servers may be send over the user plane and may indicate a time window of when the UE application may be unavailable. An AT Command may be used to send warning notifications from the ME part of the UE to applications that are hosted on the TE part of the UE.

Alternatively, it might not be necessary to explicitly indicate to the UE that the UE's NAS-SM context should be preserved while the UE is RM-DEREGISTERED. Rather, the UE may assume that the UE's NAS-SM context should be preserved while the UE is RM-DEREGISTERED whenever the AMF sets the deregistration type IE in the deregistration request to “re-registration required.” A disadvantage of this alternative would be that the NAS-SM context might end up being preserved in the network even when the AMF desires that the NAS-SM context is not preserved.

The procedure of FIG. 9 may be enhanced so that step 3 and step 3a are skipped or step 3 and step 3a may be enhanced so that, instead of unsubscribing from the UDM or indicating to the UDM that the UDM should remove the association it had stored between the SMF identity and the associated DNN and PDU session Id, the SMF will send the SM context to the UDM and request that the UDM store the SM context.

Step 4 of the procedure of FIG. 9 may be enhanced in the same way as steps 2 to 5 of the UE-initiated deregistration procedure described above.

Step 5 and 5a of the procedure of FIG. 9 may be enhanced in the same way as step 6 and 6a of UE-initiated deregistration procedure described above.

Step 6 of the procedure of FIG. 9 may enhanced so that, when the UE sends the de-registration accept message, the UE indicates to the network whether it will preserve the SM context of each PDU session. For example, the de-registration accept message may include an indication for each PDU session whose SM context the UE will save while the UE is in the RM-DEREGISTERED state. The message may further indicate to the AMF how long the UE plans to save the SM context.

Alternatively, the procedure of FIG. 9 may be enhanced so that the AMF does not request the SMF, UDM, and PCF to preserve SM context until after the AMF receives the de-registration accept message. The advantage of this approach is that, if the UE indicates that it will not save the SM context of some, or all, of the PDU session SM contexts that the AMF requested the UE to save in the deregistration request of step 2, then the AMF can avoid performing the operations that are required to ask the UDM, PCF, and SMF to save the SM-context.

The UE may display a graphical user interface (GUI) that allows the user to be notified when a network-initiated registration was requested by the network. The GUI may further allow the user to select which UE Applications need their context to be preserved during a NAS-MM reset. The UE may then determine that any PDU session(s) that are associated with the selected UE application(s) need to have their SM context preserved during a NAS-MM reset and the UE may then include the PDU session IDs of the PDU sessions that are associated with the selected UE Applications in the de-registration accept message.

In a different example, the user may have used the GUI to configure which applications need, or prefer, to have their NAS-SM context preserved during a NAS-MM reset. The UE may then use this information to determine to indicate to the network, in the PDU session establishment request, that the associated PDU session needs to have their NAS-SM context preserved during a NAS-MM reset.

As shown in FIG. 3 and FIG. 4, the UE's NAS-MM context is reset in the UE and AMF when the UE moves to the RM-DEREGISTERED state. Thus, the methods described herein may be applied to how the UE's NAS-SM state is preserved even when the UE is in the RM-DEREGISTERED state.

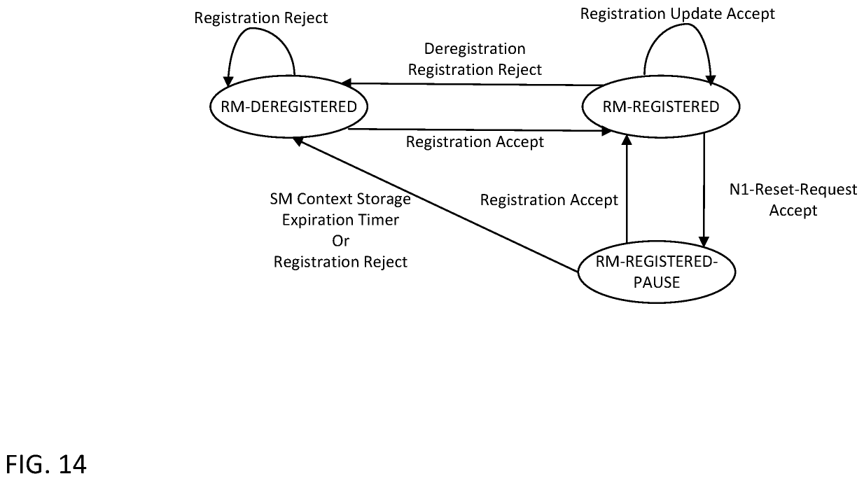

An alternative approach is to not alter the UE and AMF's handling of UE NAS-MM and NAS-SM context when the UE is in the RM-DEREGISTERED state and, instead, to create a new substate, or mode of operating, within the RM-REGISTERED state. This new state, or mode of operating, may be called RM-REGISTERED-PAUSE and may be entered upon a NAS request from the network to the UE or upon a NAS request from the AMF to the UE. The request may be called N1-Reset Request, the request may be sent by the AMF to the UE or by the UE to the AMF, and the request may cause the UE to reset its NAS-MM context. FIG. 14 illustrates how the RM state models of the AMF and UE may be enhanced to support the RM-REGISTERED-PAUSE state.

As shown in FIG. 14, the UE and AMF may enter the RM-REGISTERED-PAUSE state from the RM-REGISTERED state upon completion of an N1-Reset procedure. The UE and AMF may enter the RM-REGISTERED state from the RM-REGISTERED-PAUSED upon completion of a registration procedure. The UE and AMF may enter the RM-DEREGISTERED state from the RM-REGISTERED-PAUSED when a SM context storage expiration timer expires.

In the RM-REGISTERED-PAUSED state, the UE's NAS-MM context may be reset, and the UE's NAS-SM context may be preserved. The AMF may consider the UE to be unreachable in the RM-REGISTERED-PAUSED state.

In order to return to the RM-REGISTERED state (e.g. in order to send and receive data), the UE may initiate a registration procedure while in the RM-REGISTERED-PAUSE state. The UE may return to the RM-REGISTERED state upon completion of registration procedure that is accepted. The UE may enter the RM-DEREGISTERED state upon expiration of a SM context storage expiration timer.

The SM context storage expiration timer may be started when the UE enters the RM-REGSITERED-PAUSE state. The UE may enter the RM-DEREGISTERD state if the timer expires unless there is a registration procedure in progress. The UE may stop the timer once a registration procedure is started (e.g. when the UE is in the 5GMM-REGISTERED.ATTEMPTING-REGISTRTION-UPDATE state). Expiration of the time may mean that the timer reaches a value of 0 or the SM context storage expiration timer value that was received from the network.

The RM-REGISTERED-PAUSE state may be considered a substate of the 5GMM-REGISTEED state. An alternative name for the RM-REGISTERED-PAUSE state may be 5GMM-REGISTERED-PAUSE or 5GMM-REGISTERED-RESETING-MM-CONTEXT.

When the UE is in the RM-REGISTERED-PAUSE state, the AMF and UE should consider the UE to be in the CM-IDLE state since the UE's N1 connection will not be active.

Note that the UE may be sent multiple SM context storage expiration timers (e.g. a timer for each PDU session). The UE may maintain a separate timer for each received SM context storage expiration timer value. The UE may delete the NAS-SM context that is associated with a PDU session when the SM context storage expiration timer that is associated with that PDU session expires. The UE may stop the all the timers once a registration procedure is started (e.g. when the UE is in the 5GMM-REGISTERED.ATTEMPTING-REGISTRTION-UPDATE state). The UE may enter the RM-DEREGISTERED state once all timers have expired.

A UE may have established PDU sessions with the persistent NAS-SM context feature enabled. An event may occur at the UE and the UE may determine that the event requires that the UE reset its NAS-MM context by sending a N1-Reset Request to the network. The request may indicate that the UE will enter the CM-IDLE and RM-REGISTERED-PAUSED states, that the UE's MM context should be reset, and that the UE's NAS-SM context may be preserved while the UE is in the RM-REGISTERED-PAUSED state. The AMF may then notify the SMF(s) that are associated with the PDU sessions whose context needs to be preserved and help to coordinate preservations timers between the UE and SMF.

The N1-Reset Request may indicate to the AMF that the UE's NAS-SM context should be preserved while the UE is RM-REGISTERED-PAUSED. The request may identify which PDU session's NAS-SM context needs to be preserved by including the PDU session ID of each PDU session whose NAS-SM context needs to be preserved. For each PDU session whose contexts need to be preserved, the UE may include an N1 SM container. The N1 SM container may include an indication that the UE desires that NAS-SM context be maintained and a time value that indicates how long the UE requests that the SMF preserve the UE's NAS-SM context.

Reception of the N1-Reset Request may cause the AMF to invoke the Nsmf_PDUSession_ReleaseSMContext Request. As described earlier, the Nsmf_PDUSession_ReleaseSMContext Request may be enhanced so that the AMF sends both the SM context ID and an N1 SM container that the UE sent to the SMF. The SMF may use the contents of the N1 SM container to recognize that the UE will be moving to the RM-REGISTERED-PAUSED state and that NAS-SM context should be preserved.

The SMF's invocation of Nsmf_PDUSession_ReleaseSMContext Response may be enhanced so that the SMF may provide a SM context Storage ID and an SM context storage expiration timer to the AMF and an N1 SM container. The N1 SM container may also include the SM context Storage ID and the SM context storage expiration time. The SM context Storage ID is an identifier of the SM context. The SM context Storage ID may identify a storage location where the SM context is stored. For example, the storage location may be associated with the SMF, a UDSF, or the UDM/UDR. The SM context storage expiration time may be stored with the SM context. The SMF may use the time value that the UE included in the N1 SM container to derive the SM context storage expiration time that will be sent to the UE an N1 SM container.

The AMF may send an N1-Reset Accept message to the UE that includes the N1 SM container that was sent to the AMF by the SMF.

An event may occur at the network and the network may determine that the event requires that the UE reset its NAS-MM context by sending an N1-Reset Request to the UE, but that the NAS-SM context may be preserved while the UE's NAS-MM context is reset. The network may indicate to the UE in the N1-Reset Request that the NAS-SM context should be preserved while the UE is in the RM-REGISTERED-PAUSE state. The AMF may then notify the SMF(s) that are associated with the PDU sessions whose context needs to be preserved and help to coordinate preservations timers between the UE and SMF.

When an event triggers the AMF to send a N1-Reset Request to the UE, the N1-Reset Request may be enhanced such that the AMF may indicate to the UE that the UE's NAS-SM context should be preserved while the UE is RM-REGISTERED-PAUSE. The request may identify which PDU session's NAS-SM contexts need to be preserved by including the PDU session ID of each PDU session whose NAS-SM context needs to be preserved. For each PDU session whose context needs to be preserved, the AMF may include an N1 SM container. The N1 SM container may include an indication that the network desires that NAS-SM context be maintained and a time value that indicates how long the UE should preserve the UE's NAS-SM context.

The N1-Reset Request may also include a Reset-By timer. The Reset-By timer may indicate to the UE that the UE should enter the RM-REGISETERED-PAUSE state and reset the NAS-MM context before the timer expires. The advantage of providing such a timer is that, compared to requesting that the UE immediately enter the RM-REGISETERED-PAUSE state, is that the ME part of the UE will be able to send a Pause Warning Notification to Applications that are hosted by the TE part of the ME. The applications that receive the warning would then be able to save their associated application layer context and send a warning to any application servers that they communicate with. The warning to the application servers may be send over the user plane and may indicate a time window of when the UE Application may be unavailable. An AT Command may be used to send warning notifications from the ME part of the UE to applications that are hosted on the TE part of the UE.

The UE may send an N1-reset accept message to the AMF and the message may indicate if the UE will preserve the SM context of each PDU session. For example, the accept message may include an indication for each PDU session whose SM context the UE will save while the UE is in the RM-REGISETERED-PAUSE state. The message may further indicate to the AMF how long the UE plans to save the SM context.

As described earlier, a network function such at the AMF or UDM may initiate a procedure to initiate a reset of the UE's NAS-MM context in the UE and AMF. The trigger for the network function to initiate this procedure may be that the AMF needs to execute a network-initiated de-registration procedure due to an O&M request or in order to cause the UE to re-connect to different network nodes, a different network, a different AMF, etc.

As described earlier, a UE may initiate a procedure to initiate a reset of the UE's NAS-MM context in the UE and AMF. The trigger for the UE to initiate this procedure may be that the UE was connected to the network for emergency services and wishes to change its connection to a non-emergency connection, the trigger for the UE to initiate this procedure may be that the UE's configuration has changed and the configuration change requires a NAS-MM reset, or the trigger for the UE to initiate this procedure may be that the UE is installing a software update and the NAS-MM context needs to be reset and the UE's connection cannot be maintained while the software update is installed.

When the UE enters the RM-DEREGISTERED state, the UE may store or maintain the NAS-SM context for any PDU sessions for which the persistent NAS-SM context feature is enabled. The UE may determine that the persistent NAS-SM context feature is enabled based on negotiation with the network as described earlier in the description of the enhancements to the PDU session establishment, UE-initiated deregistration, and network-initiated deregistration procedures. As described earlier, the amount of time that the UE stores the NAS-SM context of each PDU sessions may be determined by a timer. In other words, the UE may delete the NAS-SM context if the UE detects that the timer has expired.

When the UE enters the RM-DEREGISTERED state, the SMF, UDM, PCF, and AMF may store or maintain the NAS-SM context for any PDU sessions for which the persistent NAS-SM context feature is enabled. The AMF, SMF, and UE may determine that the persistent NAS-SM context feature is enabled based on negotiation with the network as described earlier in the description of the enhancements to the PDU session establishment, UE-initiated deregistration, and network-initiated deregistration procedures.

As described earlier, the amount of time that the AMF, SMF, PCF, or UDM stores the NAS-SM context of each PDU sessions may be determined by a timer. In other words, the AMF, SMF, PCF, or UDM may delete the NAS-SM context if the AMF, SMF, PCF, or UDM detects that the timer has expired.

After resetting its NAS-MM context, a UE may send a registration request to the network in order to move into the RM-REGISTERED state. As described earlier, this may mean that the UE transitions from the RM-DEREGISTERED state to the RM-REGISTERED state or it may mean that the UE transitions from the RM-REGISTERED-PAUED state to the RM-REGISTERED.

When the UE attempts to move from the RM-DEREGISTERED state to the RM-REGISTERED state, the UE will send a registration request to the network. The registration type may indicate that the UE is performing an initial registration. The current 5G system design is that the UE is not permitted to include the “List of PDU sessions to Be Activated” information element when performing an initial registration. The registration procedure may be enhanced so that the “List of PDU sessions to Be Activated” information element may be sent to the network by the UE when performing an initial registration.

The presence of the “List of PDU sessions to Be Activated” in an initial registration request may serve as an indication to the network that the UE desires to re-establish NAS-SM context that was saved in the UE while the UE was in the RM-DEREGISTED state. The “List of PDU sessions to Be Activated” is conveyed to the network in the NAS PDU session Status IE.

When the UE attempts to move from the RM-REGISTERED-PAUSE state to the RM-REGISTERED state, the UE will send a registration request to the network. The Registration Type may indicate that the UE is performing a mobility registration update, or a new registration type may be defined to explicitly indicate that the purpose of the registration request is to move to the RM-REGISTERED state and restore NAS-SM context. The “List of PDU sessions to Be Activated” may be included in the request in order to indicate which PDU session contexts should be restored.

Alternatively, the UE may send an explicit indication to the network in a new IE to indicate that the UE desires to re-establish NAS-SM context that was saved in the UE while the UE was in the RM-DEREGISTED state.

Note that when the UE sends the initial or mobility registration request to the RAN, the UE will provide the 5G-GUTI in the RRC part of the message. The 5G-GUTI is associated with the AMF that the UE last registered to. It is likely, but not guaranteed, that the RAN will select that same AMF that provided the 5G-GUTI to serve the UE. If the RAN does select a different AMF to serve the UE, the re-establish NAS-SM context will still be able to proceed because the NAS-SM was stored in the UDM and SMF(s).

Note that the 5G-GUTI may be considered part of the NAS-MM context but may be preserved while the rest of the NAS-MM context is cleared. The advantage of preserving the 5G-GUTI is that it can be used to assist the RAN with determining which AMF should serve the UE.

The AMF may indicate to the UE in the registration accept message that the SM context of some PDU sessions could not be restored. For example, they may happen if the UE is not able to register with the slice. In other words, this may occur if the slice that is associated with the PDU session is not in the UE's Allowed NSSAI. When the NAS-SM context cannot be restored, the UE will delete the NAS-SM context. The AMF indicate to the UE that the SM context of a PDU session cannot be restored by including the PDU session ID in the registration accept message.

When context is restored, the UE may notify any applications that it hosts that the SM context is restored. For example, the notification may make the applications aware that the applications have network connectivity again and the notification may trigger the applications to use the restored PDU session with SM context recovered. As a result, an application layer message may be sent to a network server to notify the server that the application has network connectivity and is available, or reachable, with restored SM context (e.g. IP address).

Before a NAS-MM reset is executed, the UE may notify any applications that it hosts that NAS-MM context is about to be reset. The UE hosted applications may then notify an application server that the application is about to enter a period of time where the application will not be reachable. The notification may indicate to the application server a time our value to indicate how long the Application Server can assume that the UE application will preserve application layer context.

The NAS-SM context preservation feature described herein may be subject to validity criteria that specifies conditions for the applicability of the feature. The validity criteria may consist of one or more of validity area criteria, the time of the day criteria or access technology related criteria such as access technology type. For example, the validity area criteria may include one or more of a 3GPP location type for example, PLMN (public land mobile network), TAC (tracking area code), LAC (location area code), Cell Identifier, WLAN (wireless local access network) location type for example SSID (service set identifier), HESSID (homogeneous extended SSID), BSSID (basic SSID), or a geographical location type for example in the form of latitude, longitude or radius as defined in TS 23.032. The time of the day criteria may include one or more of a time start, time stop, date start, date stop and day of the week. The access technology criteria may include one or more of 3GPP RAT (radio access technology) for example UTRAN RAT (universal mobile telecommunications service terrestrial radio access network RAT), EUTRAN (evolved UTRAN) RAT, NR RAT, one or more of WLAN RAT, etc.

The UE may receive the validity criteria in a PDU session accept message or a registration accept message. When the validity criteria are received in registration accept message, the validity criteria may apply to any PDU session that is associated with the UE. When the validity criteria are received in a PDU session accept message, the validity criteria may apply only to PDU session that is associated with the PDU session accept message.

The validity criteria may be used by the UE to determine when it is permissible to perform a NAS-MM reset while preserving NAS-SM context. For example, the UE may determine that performing a NAS-MM reset while preserving NAS-SM context is only permissible when the UE's current state matches the validity criteria.

The 3rd Generation Partnership Project (3GPP) develops technical standards for cellular telecommunications network technologies, including radio access, the core transport network, and service capabilities-including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G.” 3GPP NR standards development is expected to continue and include the definition of next generation radio access technology (new RAT), which is expected to include the provision of new flexible radio access below 7 GHZ, and the provision of new ultra-mobile broadband radio access above 7 GHz. The flexible radio access is expected to consist of a new, non-backwards compatible radio access in new spectrum below 7 GHz, and it is expected to include different operating modes that may be multiplexed together in the same spectrum to address a broad set of 3GPP NR use cases with diverging requirements. The ultra-mobile broadband is expected to include cmWave and mmWave spectrum that will provide the opportunity for ultra-mobile broadband access for, e.g., indoor applications and hotspots. In particular, the ultra-mobile broadband is expected to share a common design framework with the flexible radio access below 7 GHZ, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (eMBB) ultra-reliable low-latency Communication (URLLC), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, virtual reality, home automation, robotics, and aerial drones to name a few. All of these use cases and others are contemplated herein.

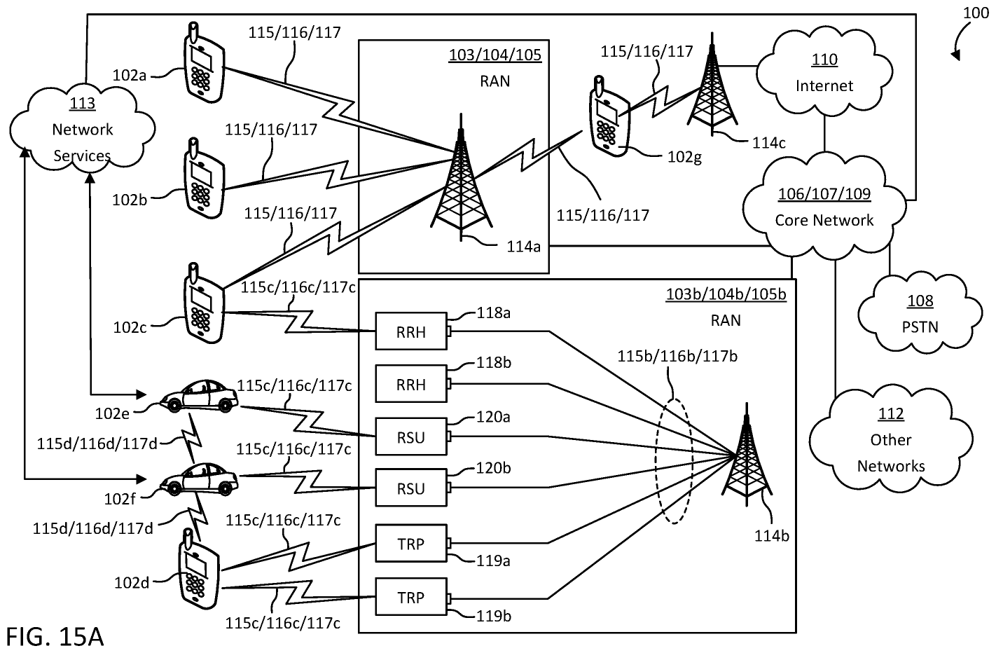

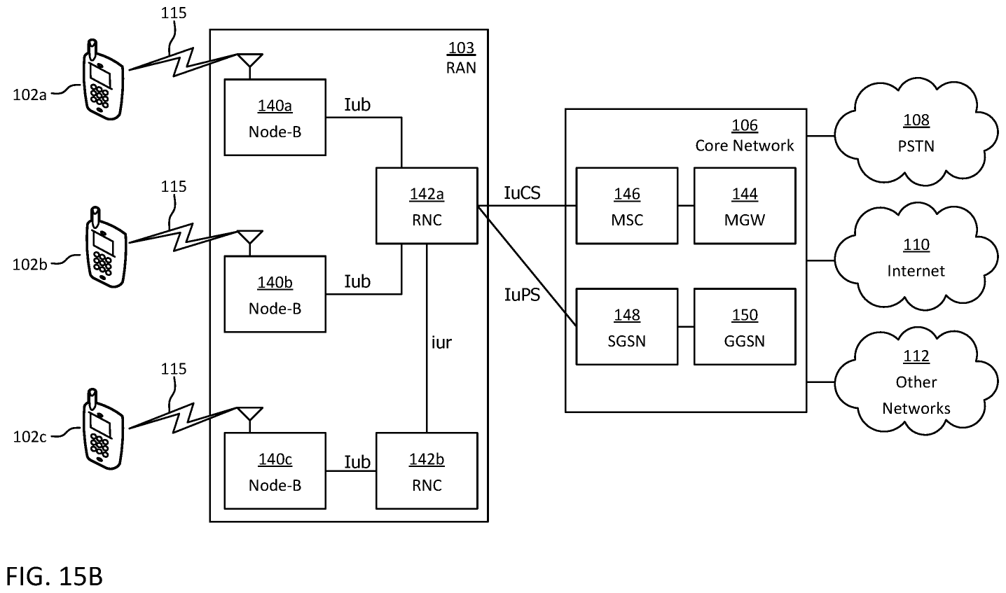

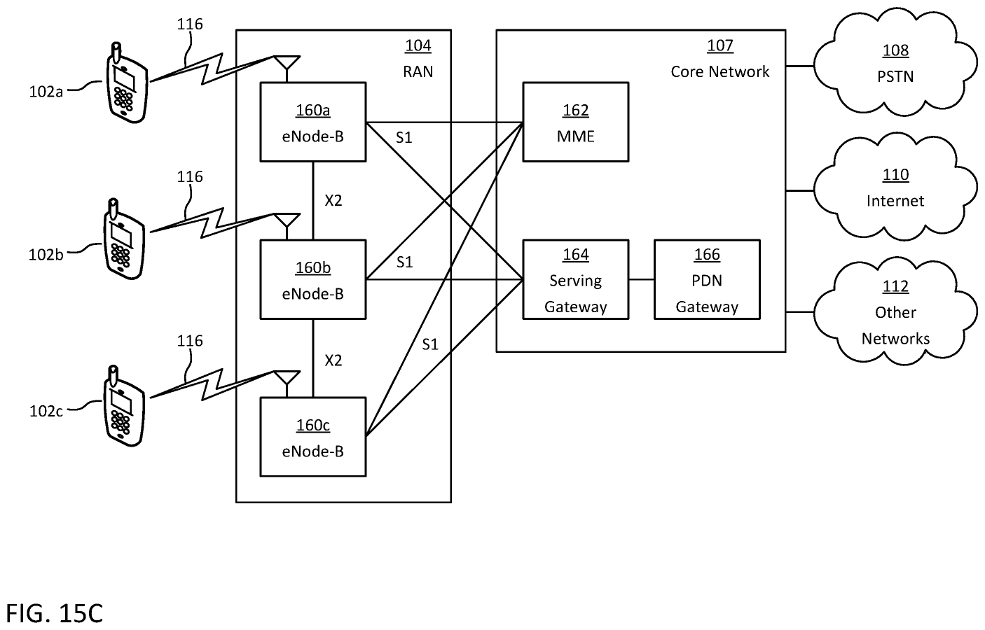

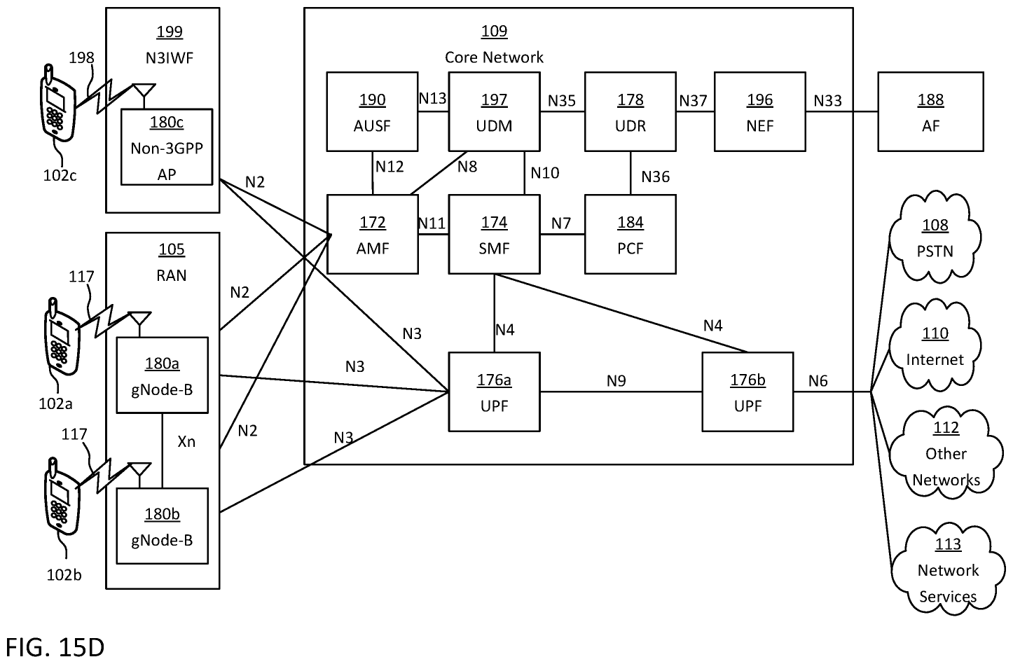

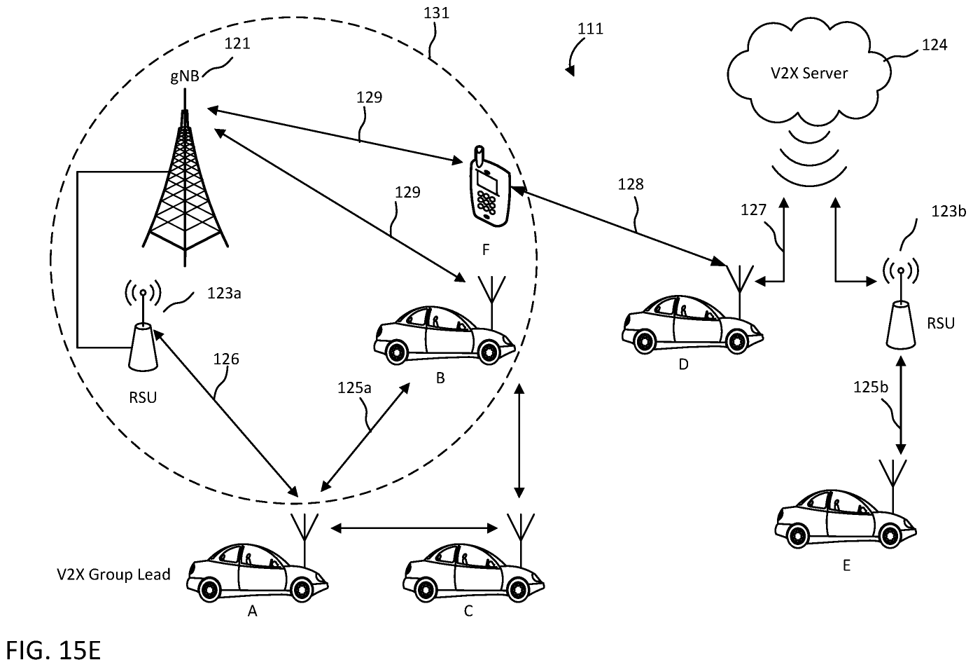

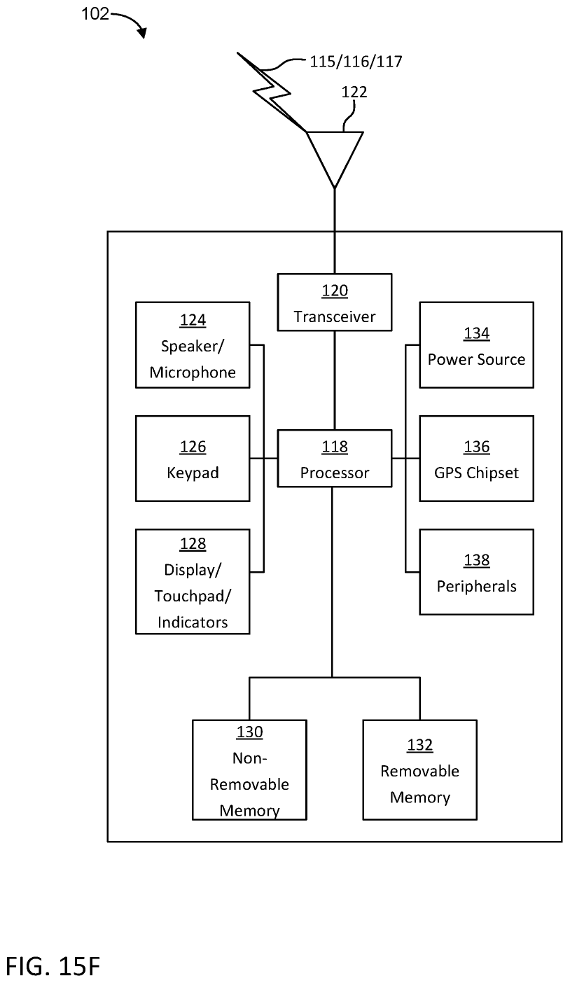

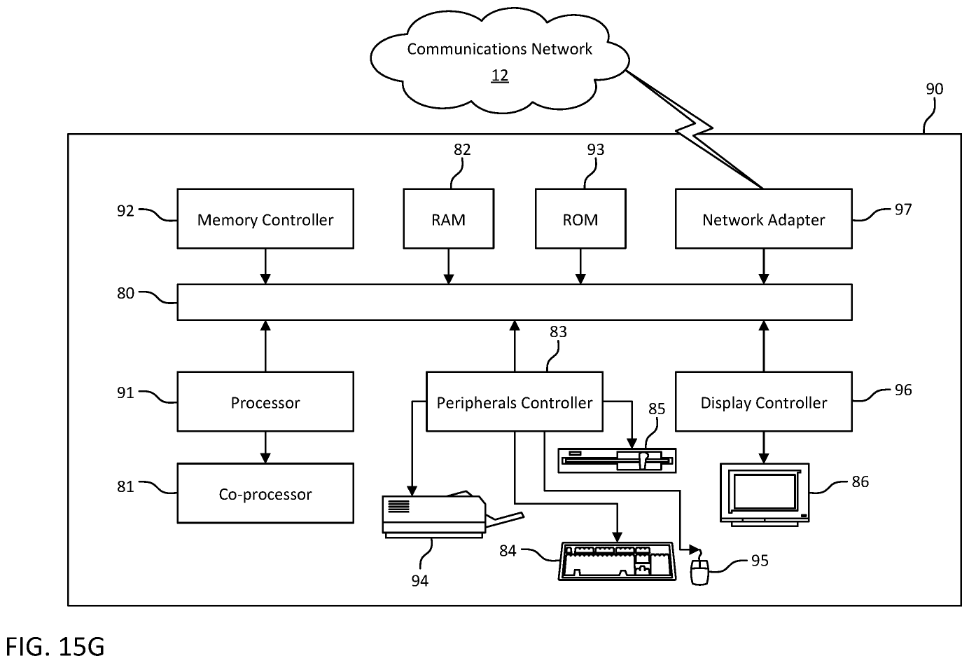

FIG. 15A illustrates an example communications system 100 in which the systems, methods, and apparatuses described and claimed herein may be used. The communications system 100 may include wireless transmit/receive units (WTRUs) 102a, 102b, 102c, 102d, 102e, 102f, and/or 102g, which generally or collectively may be referred to as WTRU 102 or WTRUs 102. The communications system 100 may include, a radio access network (RAN) 103/104/105/103b/104b/105b, a core network 106/107/109, a public switched telephone network (PSTN) 108, the Internet 110, other networks 112, and Network Services 113. 113. Network Services 113 may include, for example, a V2X server, V2X functions, a ProSe server, ProSe functions, IoT services, video streaming, and/or edge computing, etc.

It will be appreciated that the concepts disclosed herein may be used with any number of WTRUs, base stations, networks, and/or network elements. Each of the WTRUs 102 may be any type of apparatus or device configured to operate and/or communicate in a wireless environment. In the example of FIG. 15A, each of the WTRUs 102 is depicted in FIGS. 15A-E as a hand-held wireless communications apparatus. It is understood that with the wide variety of use cases contemplated for wireless communications, each WTRU may comprise or be included in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, bus or truck, a train, or an airplane, and the like.

The communications system 100 may also include a base station 114a and a base station 114b. In the example of FIG. 15A, each base stations 114a and 114b is depicted as a single element. In practice, the base stations 114a and 114b may include any number of interconnected base stations and/or network elements. Base stations 114a may be any type of device configured to wirelessly interface with at least one of the WTRUs 102a, 102b, and 102c to facilitate access to one or more communication networks, such as the core network 106/107/109, the Internet 110, Network Services 113, and/or the other networks 112. Similarly, base station 114b may be any type of device configured to wiredly and/or wirelessly interface with at least one of the Remote Radio Heads (RRHs) 118a, 118b, Transmission and Reception Points (TRPs) 119a, 119b, and/or Roadside Units (RSUs) 120a and 120b to facilitate access to one or more communication networks, such as the core network 106/107/109, the Internet 110, other networks 112, and/or Network Services 113. RRHs 118a, 118b may be any type of device configured to wirelessly interface with at least one of the WTRUs 102, e.g., WTRU 102c, to facilitate access to one or more communication networks, such as the core network 106/107/109, the Internet 110, Network Services 113, and/or other networks 112.

TRPs 119a, 119b may be any type of device configured to wirelessly interface with at least one of the WTRU 102d, to facilitate access to one or more communication networks, such as the core network 106/107/109, the Internet 110, Network Services 113, and/or other networks 112. RSUs 120a and 120b may be any type of device configured to wirelessly interface with at least one of the WTRU 102e or 102f, to facilitate access to one or more communication networks, such as the core network 106/107/109, the Internet 110, other networks 112, and/or Network Services 113. By way of example, the base stations 114a, 114b may be a Base Transceiver Station (BTS), a Node-B, an eNode B, a Home Node B, a Home eNode B, a Next Generation Node-B (gNode B), a satellite, a site controller, an access point (AP), a wireless router, and the like.

The base station 114a may be part of the RAN 103/104/105, which may also include other base stations and/or network elements (not shown), such as a Base Station Controller (BSC), a Radio Network Controller (RNC), relay nodes, etc. Similarly, the base station 114b may be part of the RAN 103b/104b/105b, which may also include other base stations and/or network elements (not shown), such as a BSC, a RNC, relay nodes, etc. The base station 114a may be configured to transmit and/or receive wireless signals within a particular geographic region, which may be referred to as a cell (not shown). Similarly, the base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, for example, the base station 114a may include three transceivers, e.g., one for each sector of the cell. The base station 114a may employ Multiple-Input Multiple Output (MIMO) technology and, therefore, may utilize multiple transceivers for each sector of the cell, for instance.

The base station 114a may communicate with one or more of the WTRUs 102a, 102b, 102c, and 102g over an air interface 115/116/117, which may be any suitable wireless communication link (e.g., Radio Frequency (RF), microwave, infrared (IR), ultraviolet (UV), visible light, cmWave, mmWave, etc.). The air interface 115/116/117 may be established using any suitable Radio Access Technology (RAT).

The base station 114b may communicate with one or more of the RRHs 118a and 118b, TRPs 119a and 119b, and/or RSUs 120a and 120b, over a wired or air interface 115b/116b/117b, which may be any suitable wired (e.g., cable, optical fiber, etc.) or wireless communication link (e.g., RF, microwave, IR, UV, visible light, cmWave, mmWave, etc.). The air interface 115b/116b/117b may be established using any suitable RAT.

The RRHs 118a, 118b, TRPs 119a, 119b and/or RSUs 120a, 120b, may communicate with one or more of the WTRUs 102c, 102d, 102e, 102f over an air interface 115c/116c/117c, which may be any suitable wireless communication link (e.g., RF, microwave, IR, ultraviolet UV, visible light, cmWave, mmWave, etc.) The air interface 115c/116c/117c may be established using any suitable RAT.

The WTRUs 102 may communicate with one another over a direct air interface 115d/116d/117d, such as sidelink communication which may be any suitable wireless communication link (e.g., RF, microwave, IR, ultraviolet UV, visible light, cmWave, mmWave, etc.) The air interface 115d/116d/117d may be established using any suitable RAT.

The communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 119a, 119b and/or RSUs 120a and 120b in the RAN 103b/104b/105b and the WTRUs 102c, 102d, 102e, and 102f, may implement a radio technology such as Universal Mobile Telecommunications System (UMTS) Terrestrial Radio Access (UTRA), which may establish the air interface 115/116/117 and/or 115c/116c/117c respectively using Wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

The base station 114a in the RAN 103/104/105 and the WTRUs 102a, 102b, 102c, and 102g, or RRHs 118a and 118b, TRPs 119a and 119b, and/or RSUs 120a and 120b in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) and/or LTE-Advanced (LTE-A), for example. The air interface 115/116/117 or 115c/116c/117c may implement 3GPP NR technology. The LTE and LTE-A technology may include LTE D2D and/or V2X technologies and interfaces (such as sidelink communications, etc.) Similarly, the 3GPP NR technology may include NR V2X technologies and interfaces (such as sidelink communications, etc.)

The base station 114a in the RAN 103/104/105 and the WTRUs 102a, 102b, 102c, and 102g or RRHs 118a and 118b, TRPs 119a and 119b, and/or RSUs 120a and 120b in the RAN 103b/104b/105b and the WTRUs 102c, 102d, 102e, and 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 15A may be a wireless router, Home Node B, Home eNode B, or access point, for example, and may utilize any suitable RAT for facilitating wireless connectivity in a localized area, such as a place of business, a home, a vehicle, a train, an aerial, a satellite, a manufactory, a campus, and the like. The base station 114c and the WTRUs 102, e.g., WTRU 102e, may implement a radio technology such as IEEE 802.11 to establish a Wireless Local Area Network (WLAN). Similarly, the base station 114c and the WTRUs 102, e.g., WTRU 102d, may implement a radio technology such as IEEE 802.15 to establish a wireless personal area network (WPAN). The base station 114c and the WTRUs 102, e.g., WRTU 102e, may utilize a cellular-based RAT (e.g., WCDMA, CDMA2000, GSM, LTE, LTE-A, NR, etc.) to establish a picocell or femtocell. As shown in FIG. 15A, the base station 114c may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, messaging, authorization and authentication, applications, and/or Voice Over Internet Protocol (VOIP) services to one or more of the WTRUs 102. For example, the core network 106/107/109 may provide call control, billing services, mobile location-based services, pre-paid calling, Internet connectivity, packet data network connectivity, Ethernet connectivity, video distribution, etc., and/or perform high-level security functions, such as user authentication.

Although not shown in FIG. 15A, it will be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM or NR radio technology.

The core network 106/107/109 may also serve as a gateway for the WTRUs 102 to access the PSTN 108, the Internet 110, and/or other networks 112. The PSTN 108 may include circuit-switched telephone networks that provide Plain Old Telephone Service (POTS). The Internet 110 may include a global system of interconnected computer networks and devices that use common communication protocols, such as the Transmission Control Protocol (TCP), User Datagram Protocol (UDP), and the internet protocol (IP) in the TCP/IP internet protocol suite. The other networks 112 may include wired or wireless communications networks owned and/or operated by other service providers. For example, the networks 112 may include any type of packet data network (e.g., an IEEE 802.3 Ethernet network) or another core network connected to one or more RANs, which may employ the same RAT as the RAN 103/104/105 and/or RAN 103b/104b/105b or a different RAT.

Some or all of the WTRUs 102a, 102b, 102c, 102d, 102e, and 102f in the communications system 100 may include multi-mode capabilities, e.g., the WTRUs 102a, 102b, 102c, 102d, 102e, and 102f may include multiple transceivers for communicating with different wireless networks over different wireless links. For example, the WTRU 102g shown in FIG. 15A may be configured to communicate with the base station 114a, which may employ a cellular-based radio technology, and with the base station 114c, which may employ an IEEE 802 radio technology.

Although not shown in FIG. 15A, it will be appreciated that a User Equipment may make a wired connection to a gateway. The gateway maybe a Residential Gateway (RG). The RG may provide connectivity to a Core Network 106/107/109. It will be appreciated that many of the ideas contained herein may equally apply to UEs that are WTRUs and UEs that use a wired connection to connect to a network. For example, the ideas that apply to the wireless interfaces 115, 116, 117 and 115c/116c/117c may equally apply to a wired connection.

FIG. 15B is a system diagram of an example RAN 103 and core network 106. As noted above, the RAN 103 may employ a UTRA radio technology to communicate with the WTRUs 102a, 102b, and 102c over the air interface 115. The RAN 103 may also be in communication with the core network 106. As shown in FIG. 15B, the RAN 103 may include Node-Bs 140a, 140b, and 140c, which may each include one or more transceivers for communicating with the WTRUs 102a, 102b, and 102c over the air interface 115. The Node-Bs 140a, 140b, and 140c may each be associated with a particular cell (not shown) within the RAN 103. The RAN 103 may also include RNCs 142a, 142b. It will be appreciated that the RAN 103 may include any number of Node-Bs and Radio Network Controllers (RNCs.)

As shown in FIG. 15B, the Node-Bs 140a, 140b may be in communication with the RNC 142a. Additionally, the Node-B 140c may be in communication with the RNC 142b. The Node-Bs 140a, 140b, and 140c may communicate with the respective RNCs 142a and 142b via an Iub interface. The RNCs 142a and 142b may be in communication with one another via an Iur interface. Each of the RNCs 142a and 142b may be configured to control the respective Node-Bs 140a, 140b, and 140c to which it is connected. In addition, each of the RNCs 142a and 142b may be configured to carry out or support other functionality, such as outer loop power control, load control, admission control, packet scheduling, handover control, macro-diversity, security functions, data encryption, and the like.

The core network 106 shown in FIG. 15B may include a media gateway (MGW) 144, a Mobile Switching Center (MSC) 146, a Serving GPRS Support Node (SGSN) 148, and/or a Gateway GPRS Support Node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and 102c with access to circuit-switched networks, such as the PSTN 108, to facilitate communications between the WTRUs 102a, 102b, and 102c, and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and 102c with access to packet-switched networks, such as the Internet 110, to facilitate communications between and the WTRUs 102a, 102b, and 102c, and IP-enabled devices.

The core network 106 may also be connected to the other networks 112, which may include other wired or wireless networks that are owned and/or operated by other service providers.

FIG. 15C is a system diagram of an example RAN 104 and core network 107. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, and 160c, though it will be appreciated that the RAN 104 may include any number of eNode-Bs. The eNode-Bs 160a, 160b, and 160c may each include one or more transceivers for communicating with the WTRUs 102a, 102b, and 102c over the air interface 116. For example, the eNode-Bs 160a, 160b, and 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 15C, the eNode-Bs 160a, 160b, and 160c may communicate with one another over an X2 interface.

The core network 107 shown in FIG. 15C may include a Mobility Management Gateway (MME) 162, a serving gateway 164, and a Packet Data Network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, and 102c, bearer activation/deactivation, selecting a particular serving gateway during an initial attach of the WTRUs 102a, 102b, and 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, and 102c. The serving gateway 164 may also perform other functions, such as anchoring user planes during inter-eNode B handovers, triggering paging when downlink data is available for the WTRUs 102a, 102b, and 102c, managing and storing contexts of the WTRUs 102a, 102b, and 102c, and the like.

The serving gateway 164 may also be connected to the PDN gateway 166, which may provide the WTRUs 102a, 102b, and 102c with access to packet-switched networks, such as the Internet 110, to facilitate communications between the WTRUs 102a, 102b, 102c, and IP-enabled devices.

The core network 107 may facilitate communications with other networks. For example, the core network 107 may provide the WTRUs 102a, 102b, and 102c with access to circuit-switched networks, such as the PSTN 108, to facilitate communications between the WTRUs 102a, 102b, and 102c and traditional land-line communications devices. For example, the core network 107 may include, or may communicate with, an IP gateway (e.g., an IP Multimedia Subsystem (IMS) server) that serves as an interface between the core network 107 and the PSTN 108. In addition, the core network 107 may provide the WTRUs 102a, 102b, and 102c with access to the networks 112, which may include other wired or wireless networks that are owned and/or operated by other service providers.

FIG. 15D is a system diagram of an example RAN 105 and core network 109. The RAN 105 may employ an NR radio technology to communicate with the WTRUs 102a and 102b over the air interface 117. The RAN 105 may also be in communication with the core network 109. A Non-3GPP Interworking Function (N3IWF) 199 may employ a non-3GPP radio technology to communicate with the WTRU 102c over the air interface 198. The N3IWF 199 may also be in communication with the core network 109.

The RAN 105 may include gNode-Bs 180a and 180b. It will be appreciated that the RAN 105 may include any number of gNode-Bs. The gNode-Bs 180a and 180b may each include one or more transceivers for communicating with the WTRUs 102a and 102b over the air interface 117. When integrated access and backhaul connection are used, the same air interface may be used between the WTRUs and gNode-Bs, which may be the core network 109 via one or multiple gNBs. The gNode-Bs 180a and 180b may implement MIMO, MU-MIMO, and/or digital beamforming technology. Thus, the gNode-B 180a, for example, may use multiple antennas to transmit wireless signals to, and receive wireless signals from, the WTRU 102a. It should be appreciated that the RAN 105 may employ of other types of base stations such as an eNode-B. It will also be appreciated the RAN 105 may employ more than one type of base station. For example, the RAN may employ eNode-Bs and gNode-Bs.

The N3IWF 199 may include a non-3GPP Access Point 180c. It will be appreciated that the N3IWF 199 may include any number of non-3GPP Access Points. The non-3GPP Access Point 180c may include one or more transceivers for communicating with the WTRUs 102c over the air interface 198. The non-3GPP Access Point 180c may use the 802.11 protocol to communicate with the WTRU 102c over the air interface 198.

Each of the gNode-Bs 180a and 180b may be associated with a particular cell (not shown) and may be configured to handle radio resource management decisions, handover decisions, scheduling of users in the uplink and/or downlink, and the like. As shown in FIG. 15D, the gNode-Bs 180a and 180b may communicate with one another over an Xn interface, for example.

The core network 109 shown in FIG. 15D may be a 5G core network (5GC). The core network 109 may offer numerous communication services to customers who are interconnected by the radio access network. The core network 109 comprises a number of entities that perform the functionality of the core network. As used herein, the term “core network entity” or “network function” refers to any entity that performs one or more functionalities of a core network. It is understood that such core network entities may be logical entities that are implemented in the form of computer-executable instructions (software) stored in a memory of, and executing on a processor of, an apparatus configured for wireless and/or network communications or a computer system, such as system 90 illustrated in FIG. 15G.

In the example of FIG. 15D, the 5G Core Network 109 may include an access and mobility management function (AMF) 172, a Session Management Function (SMF) 174, User Plane Functions (UPFs) 176a and 176b, a User Data Management Function (UDM) 197, an Authentication Server Function (AUSF) 190, a Network Exposure Function (NEF) 196, a Policy Control Function (PCF) 184, a Non-3GPP Interworking Function (N3IWF) 199, a User Data Repository (UDR) 178. While each of the foregoing elements are depicted as part of the 5G core network 109, it will be appreciated that any one of these elements may be owned and/or operated by an entity other than the core network operator. It will also be appreciated that a 5G core network may not consist of all of these elements, may consist of additional elements, and may consist of multiple instances of each of these elements. FIG. 15D shows that network functions directly connect to one another, however, it should be appreciated that they may communicate via routing agents such as a diameter routing agent or message buses.

In the example of FIG. 15D, connectivity between network functions is achieved via a set of interfaces, or reference points. It will be appreciated that network functions could be modeled, described, or implemented as a set of services that are invoked, or called, by other network functions or services. Invocation of a Network Function service may be achieved via a direct connection between network functions, an exchange of messaging on a message bus, calling a software function, etc.

The AMF 172 may be connected to the RAN 105 via an N2 interface and may serve as a control node. For example, the AMF 172 may be responsible for registration management, connection management, reachability management, access authentication, access authorization. The AMF may be responsible forwarding user plane tunnel configuration information to the RAN 105 via the N2 interface. The AMF 172 may receive the user plane tunnel configuration information from the SMF via an N11 interface. The AMF 172 may generally route and forward NAS packets to/from the WTRUs 102a, 102b, and 102c via an N1 interface. The N1 interface is not shown in FIG. 15D.

The SMF 174 may be connected to the AMF 172 via an N11 interface. Similarly, the SMF may be connected to the PCF 184 via an N7 interface, and to the UPFs 176a and 176b via an N4 interface. The SMF 174 may serve as a control node. For example, the SMF 174 may be responsible for Session Management, IP address allocation for the WTRUs 102a, 102b, and 102c, management and configuration of traffic steering rules in the UPF 176a and UPF 176b, and generation of downlink data notifications to the AMF 172.

The UPF 176a and UPF176b may provide the WTRUs 102a, 102b, and 102c with access to a Packet Data Network (PDN), such as the Internet 110, to facilitate communications between the WTRUs 102a, 102b, and 102c and other devices. The UPF 176a and UPF 176b may also provide the WTRUs 102a, 102b, and 102c with access to other types of packet data networks. For example, Other Networks 112 may be Ethernet Networks or any type of network that exchanges packets of data. The UPF 176a and UPF 176b may receive traffic steering rules from the SMF 174 via the N4 interface. The UPF 176a and UPF 176b may provide access to a packet data network by connecting a packet data network with an N6 interface or by connecting to each other and to other UPFs via an N9 interface. In addition to providing access to packet data networks, the UPF 176 may be responsible packet routing and forwarding, policy rule enforcement, quality of service handling for user plane traffic, downlink packet buffering.

The AMF 172 may also be connected to the N3IWF 199, for example, via an N2 interface. The N3IWF facilitates a connection between the WTRU 102c and the 5G core network 170, for example, via radio interface technologies that are not defined by 3GPP. The AMF may interact with the N3IWF 199 in the same, or similar, manner that it interacts with the RAN 105.

The PCF 184 may be connected to the SMF 174 via an N7 interface, connected to the AMF 172 via an N15 interface, and to an Application Function (AF) 188 via an N5 interface. The N15 and N5 interfaces are not shown in FIG. 15D. The PCF 184 may provide policy rules to control plane nodes such as the AMF 172 and SMF 174, allowing the control plane nodes to enforce these rules. The PCF 184 may send policies to the AMF 172 for the WTRUs 102a, 102b, and 102c so that the AMF may deliver the policies to the WTRUs 102a, 102b, and 102c via an N1 interface. Policies may then be enforced, or applied, at the WTRUs 102a, 102b, and 102c.

The UDR 178 may act as a repository for authentication credentials and subscription information. The UDR may connect to network functions, so that network function can add to, read from, and modify the data that is in the repository. For example, the UDR 178 may connect to the PCF 184 via an N36 interface. Similarly, the UDR 178 may connect to the NEF 196 via an N37 interface, and the UDR 178 may connect to the UDM 197 via an N35 interface.

The UDM 197 may serve as an interface between the UDR 178 and other network functions. The UDM 197 may authorize network functions to access of the UDR 178. For example, the UDM 197 may connect to the AMF 172 via an N8 interface, the UDM 197 may connect to the SMF 174 via an N10 interface. Similarly, the UDM 197 may connect to the AUSF 190 via an N13 interface. The UDR 178 and UDM 197 may be tightly integrated.

The AUSF 190 performs authentication related operations and connects to the UDM 178 via an N13 interface and to the AMF 172 via an N12 interface.

The NEF 196 exposes capabilities and services in the 5G core network 109 to Application Functions (AF) 188. Exposure may occur on the N33 API interface. The NEF may connect to an AF 188 via an N33 interface, and it may connect to other network functions in order to expose the capabilities and services of the 5G core network 109.

Application Functions 188 may interact with network functions in the 5G Core Network 109. Interaction between the Application Functions 188 and network functions may be via a direct interface or may occur via the NEF 196. The Application Functions 188 may be considered part of the 5G Core Network 109 or may be external to the 5G Core Network 109 and deployed by enterprises that have a business relationship with the mobile network operator.

Network Slicing is a mechanism that could be used by mobile network operators to support one or more ‘virtual’ core networks behind the operator's air interface. This involves ‘slicing’ the core network into one or more virtual networks to support different RANs or different service types running across a single RAN. Network slicing enables the operator to create networks customized to provide optimized solutions for different market scenarios which demands diverse requirements, e.g., in the areas of functionality, performance, and isolation.

3GPP has designed the 5G core network to support Network Slicing. Network Slicing is a useful tool that network operators can use to support the diverse set of 5G use cases (e.g., massive IoT, critical communications, V2X, and enhanced mobile broadband) which demand diverse and sometimes extreme requirements. Without the use of network slicing techniques, it is likely that the network architecture would not be flexible and scalable enough to efficiently support a wider range of use cases need when each use case has its own specific set of performance, scalability, and availability requirements. Furthermore, introduction of new network services should be made more efficient.

Referring again to FIG. 15D, in a network slicing scenario, a WTRU 102a, 102b, or 102c may connect to an AMF 172, via an N1 interface. The AMF may be logically part of one or more slices. The AMF may coordinate the connection or communication of WTRU 102a, 102b, or 102c with one or more UPF 176a and 176b, SMF 174, and other network functions. Each of the UPFs 176a and 176b, SMF 174, and other network functions may be part of the same slice or different slices. When they are part of different slices, they may be isolated from each other in the sense that they may utilize different computing resources, security credentials, etc.

The core network 109 may facilitate communications with other networks. For example, the core network 109 may include, or may communicate with, an IP gateway, such as an IP Multimedia Subsystem (IMS) server, which serves as an interface between the 5G core network 109 and a PSTN 108. For example, the core network 109 may include, or communicate with a short message service (SMS) service center that facilities communication via the short message service. For example, the 5G core network 109 may facilitate the exchange of non-IP data packets between the WTRUs 102a, 102b, and 102c and servers or applications functions 188. In addition, the core network 170 may provide the WTRUs 102a, 102b, and 102c with access to the networks 112, which may include other wired or wireless networks that are owned and/or operated by other service providers.

The core network entities described herein and illustrated in FIG. 15A, FIG. 15C, FIG. 15D, and FIG. 15E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIGS. 15A-E are provided by way of example only, and it is understood that the subject matter disclosed and claimed herein may be embodied or implemented in any similar communication system, whether presently defined or defined in the future.

FIG. 15E illustrates an example communications system 111 in which the systems, methods, apparatuses described herein may be used. Communications system 111 may include Wireless Transmit/Receive Units (WTRUs) A, B, C, D, E, F, a base station gNB 121, a V2X server 124, and Roadside Units (RSUs) 123a and 123b. In practice, the concepts presented herein may be applied to any number of WTRUs, base station gNBs, V2X networks, and/or other network elements. One or several or all WTRUs A, B, C, D, E, and F may be out of range of the access network coverage 131. WTRUs A, B, and C form a V2X group, among which WTRU A is the group lead and WTRUs B and C are group members.

WTRUs A, B, C, D, E, and F may communicate with each other over a Uu interface 129 via the gNB 121 if they are within the access network coverage 131. In the example of FIG. 15E, WTRUs B and F are shown within access network coverage 131. WTRUS A, B, C, D, E, and F may communicate with each other directly via a sidelink interface (e.g., PC5 or NR PC5) such as interface 125a, 125b, or 128, whether they are under the access network coverage 131 or out of the access network coverage 131. For instance, in the example of FIG. 15E, WRTU D, which is outside of the access network coverage 131, communicates with WTRU F, which is inside the coverage 131.

WTRUs A, B, C, D, E, and F may communicate with RSU 123a or 123b via a Vehicle-to-Network (V2N) 133 or sidelink interface 125b. WTRUs A, B, C, D, E, and F may communicate to a V2X Server 124 via a Vehicle-to-Infrastructure (V2I) interface 127. WTRUs A, B, C, D, E, and F may communicate to another UE via a Vehicle-to-Person (V2P) interface 128.

FIG. 15F is a block diagram of an example apparatus or device WTRU 102 that may be configured for wireless communications and operations in accordance with the systems, methods, and apparatuses described herein, such as a WTRU 102 of FIGS. 15A-E. As shown in FIG. 15F, the example WTRU 102 may include a processor 118, a transceiver 120, a transmit/receive element 122, a speaker/microphone 124, a keypad 126, a display/touchpad/indicators 128, non-removable memory 130, removable memory 132, a power source 134, a global positioning system (GPS) chipset 136, and other peripherals 138. It will be appreciated that the WTRU 102 may include any sub-combination of the foregoing elements. Also, the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, a next generation node-B (gNode-B), and proxy nodes, among others, may include some or all of the elements depicted in FIG. 15F and described herein.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 15F depicts the processor 118 and the transceiver 120 as separate components, it will be appreciated that the processor 118 and the transceiver 120 may be integrated together in an electronic package or chip.

The transmit/receive element 122 of a UE may be configured to transmit signals to, or receive signals from, a base station (e.g., the base station 114a of FIG. 15A) over the air interface 115/116/117 or another UE over the air interface 115d/116d/117d. For example, the transmit/receive element 122 may be an antenna configured to transmit and/or receive RF signals. The transmit/receive element 122 may be an emitter/detector configured to transmit and/or receive IR, UV, or visible light signals, for example. The transmit/receive element 122 may be configured to transmit and receive both RF and light signals. It will be appreciated that the transmit/receive element 122 may be configured to transmit and/or receive any combination of wireless or wired signals.

In addition, although the transmit/receive element 122 is depicted in FIG. 15F as a single element, the WTRU 102 may include any number of transmit/receive elements 122. More specifically, the WTRU 102 may employ MIMO technology. Thus, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, for example NR and IEEE 802.11 or NR and E-UTRA, or to communicate with the same RAT via multiple beams to different RRHs, TRPs, RSUs, or nodes.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit. The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. The processor 118 may access information from, and store data in, memory that is not physically located on the WTRU 102, such as on a server that is hosted in the cloud or in an edge computing platform or in a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method.

The processor 118 may further be coupled to other peripherals 138, which may include one or more software and/or hardware modules that provide additional features, functionality, and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be included in other apparatuses or devices, such as a sensor, consumer electronics, a wearable device such as a smart watch or smart clothing, a medical or eHealth device, a robot, industrial equipment, a drone, a vehicle such as a car, truck, train, or an airplane. The WTRU 102 may connect to other components, modules, or systems of such apparatuses or devices via one or more interconnect interfaces, such as an interconnect interface that may comprise one of the peripherals 138.

FIG. 15G is a block diagram of an exemplary computing system 90 in which one or more apparatuses of the communications networks illustrated in FIG. 15A, FIG. 15C, FIG. 15D and FIG. 15E may be embodied, such as certain nodes or functional entities in the RAN 103/104/105, Core Network 106/107/109, PSTN 108, Internet 110, Other Networks 112, or Network Services 113. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 may be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a wireless or wired network adapter 97, that may be used to connect computing system 90 to an external communications network or devices, such as the RAN 103/104/105, Core Network 106/107/109, PSTN 108, Internet 110, WTRUs 102, or Other Networks 112 of FIGS. 15A-1E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

It is understood that any or all of the apparatuses, systems, methods, and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations, or functions described herein may be implemented in the form of such computer executable instructions, executing on the processor of an apparatus or computing system configured for wireless and/or wired network communications. Computer readable storage media includes volatile and nonvolatile, removable, and non-removable media implemented in any non-transitory (e.g., tangible, or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information, and which may be accessed by a computing system.

TABLE 1
Acronyms

| | |
|---|---|
| AF | Application Function |
| AMF | Access and Mobility Management Function |
| ANDSP | Access Network Discovery & Selection Policy |
| API | Application Programmer Interface |
| APN | Access Point Name |
| AS | Application Server |
| AT | Attention |
| CL | Classifier |
| CM | Connection Management |
| DNN | Data Network Name |
| GUTI | Globally Unique Temporary Identifier |
| HPLMN | Home Public Land Mobile Network |
| IP | Internet Protocol |
| LADN | Local Access Data Network |
| LCS | Location Service |
| LMF | Location Management Function |
| MM | Mobility Management |
| NAS | Non-Access Stratum |
| N3IWF | Non-3GPP Interworking Function |
| NGAP | NG Application Protocol |
| NRF | NF Repository Function |
| NSSAI | Network Slice Selection Assistance Information |
| PCF | Policy Control Function |
| PDU | Protocol Data Unit |
| RAN | Radio Access Network |
| RSD | route selection descriptor |
| RM | Registration Management |
| SM | Session Management |
| SMF | Session Management Function |
| SMSF | Short Message Service (SMS) Function |
| S-NSSAI | Single Network Slice Selection Assistance Information |
| SSC | Session and Service Continuity |
| TNGF | Trusted Non-3GPP Gateway Function |
| TWAP | Trusted WLAN Access Point |
| UDM | Unified Data Management |
| UDR | Unified Data Repository |
| UE | User Equipment |
| UPF | User Plane Function |
| URSP | UE Route Selection Policy |

TABLE 2
UE Route Selection Policy

| | | | PCF permitted | |
|---|---|---|---|---|
| Information | | | to modify | |
| name | Description | Category | in a URSP | Scope |
| URSP | 1 or more URSP rules as | Mandatory | Yes | UE context |
| rules | specified in table 6.6.2.1- | | | |
| | 2 of 3GPP TS 23.503, | | | |
| | Policy and charging | | | |
| | control framework for | | | |
| | the 5G System (5GS); | | | |
| | Stage 2 | | | |

TABLE 3
UE Route Selection Policy Rule

| | | | PCF permitted | |
|---|---|---|---|---|
| Information | | | to modify in a | |
| name | Description | Category | UE context | Scope |
| rule | Determines the order the | Mandatory | Yes | UE context |
| precedence | URSP rule is enforced in | (NOTE 1) | | |
| | the UE. | | | |
| Traffic | This part defines the | Mandatory | | |
| descriptor | Traffic descriptor | (NOTE 3) | | |
| | components for the URSP | | | |
| | rule. | | | |
| Application | It consists of OSId and | Optional | Yes | UE context |
| descriptors | OSAppId(s). (NOTE 2) | | | |
| IP | Destination IP 3 tuple(s) | Optional | Yes | UE context |
| descriptors | (IP address or IPv6 | | | |
| (NOTE 5) | network prefix, port | | | |
| | number, protocol ID of | | | |
| | the protocol above IP). | | | |
| Domain | Destination FQDN(s) | Optional | Yes | UE context |
| descriptors | | | | |
| Non-IP | Descriptor(s) for | Optional | Yes | UE context |
| descriptors | destination information of | | | |
| (NOTE 5) | non-IP traffic | | | |
| DNN | This is matched against | Optional | Yes | UE context |
| | the DNN information | | | |
| | provided by the | | | |
| | application. | | | |
| rule | Determines the order the | Mandatory | Yes | UE context |
| precedence | URSP rule is enforced in | (NOTE 1) | | |
| | the UE. | | | |
| Connection | This is matched against | Optional | Yes | UE context |
| Capabilities | the information provided | | | |
| | by a UE application when | | | |
| | it requests a network | | | |
| | connection with certain | | | |
| | capabilities. (NOTE 4) | | | |
| List of route | A list of route selection | Mandatory | | |
| selection | descriptors. The | | | |
| descriptors | components of a route | | | |
| | selection descriptor are | | | |
| | described in table 6.6.2.1- | | | |
| | 3 3GPP TS 23.503, Policy | | | |
| | and charging control | | | |
| | framework for the 5G | | | |
| | System (5GS); Stage 2. | | | |
| rule | Determines the order the | Mandatory | Yes | UE context |
| precedence | URSP rule is enforced in | (NOTE 1) | | |
| | the UE. | | | |

(NOTE 1)
Rules in a URSP shall have different precedence values.
(NOTE 2)
The information is used to identify the Application(s) that is(are) running on the UE's OS. The OSId does not include an OS version number. The OSAppId does not include a version number for the application.
(NOTE 3)
At least one of the Traffic descriptor components shall be present.
(NOTE 4)
The format and some values of Connection Capabilities, e.g. “ims”, “mms”, “internet”, etc., are defined in 3GPP TS 24.526, User Equipment (UE) policies for 5G System (5GS); Stage 3. More than one connection capabilities value can be provided.
(NOTE 5)
A URSP rule cannot contain the combination of the Traffic descriptor components IP descriptors and Non-IP descriptors.

TABLE 4
Route Selection Descriptors

| | | | PCF permitted | |
|---|---|---|---|---|
| Information | | | to modify in | |
| name | Description | Category | URSP | Scope |
| route | Determines the order in | Mandatory | Yes | UE context |
| selection | which the route selection | (NOTE 1) | | |
| descriptor | descriptors are to be | | | |
| precedence | applied. | | | |
| route | This part defines the route | Mandatory | | |
| selection | selection components | (NOTE 2) | | |
| components | | | | |
| SSC Mode | One single value of SSC | Optional | Yes | UE context |
| Selection | mode. | | | |
| | (NOTE 5) | | | |
| Network | Either a single value or a | Optional | Yes | UE context |
| Slice | list of values of S- | (NOTE 3) | | |
| Selection | NSSAI(s). | | | |
| DNN | Either a single value or a | Optional | Yes | UE context |
| Selection | list of values of DNN(s). | | | |
| PDU session | One single value of PDU | Optional | Yes | UE context |
| Type | session Type | (NOTE 8) | | |
| Selection | | | | |
| Non- | Indicates if the traffic of | Optional | Yes | UE context |
| Seamless | the matching application | (NOTE 4) | | |
| Offload | is to be offloaded to non- | | | |
| indication | 3GPP access outside of a | | | |
| | PDU session. | | | |
| Access Type | Indicates the preferred | Optional | Yes | UE context |
| preference | Access Type (3GPP or | | | |
| | non-3GPP or Multi- | | | |
| | Access) when the UE | | | |
| | establishes a PDU session | | | |
| | for the matching | | | |
| | application. | | | |
| Route | This part defines the | Optional | | |
| Selection | Route Validation Criteria | | | |
| Validation | components | | | |
| Criteria | | | | |
| (NOTE 6) | | | | |
| time window | The time window when | Optional | Yes | UE context |
| | the matching traffic is | | | |
| | allowed. The RSD is not | | | |
| | considered to be valid if | | | |
| | the current time is not in | | | |
| | the time window. | | | |
| location | The UE location where | Optional | Yes | UE context |
| criteria | the matching traffic is | | | |
| | allowed. The RSD rule is | | | |
| | not considered to be valid | | | |
| | if the UE location does | | | |
| | not match the location | | | |
| | criteria. | | | |

(NOTE 1)
Every route selection descriptor in the list shall have a different precedence value.
(NOTE 2)
At least one of the route selection components shall be present.
(NOTE 3)
When the Subscription Information contains only one S-NSSAI in UDR, the PCF needs not provision the UE with S-NSSAI in the Network Slice Selection information. The “match all” URSP rule has one S-NSSAI at most.
(NOTE 4)
If this indication is present in a route selection descriptor, no other components shall be included in the route selection descriptor.
(NOTE 5)
The SSC Mode 3 shall only be used when the PDU session Type is IP.
(NOTE 6)
The route selection descriptor is not considered valid unless all the provided Validation Criteria are met.
NOTE 7:
In this Release of specification, inclusion of the Validation Criteria in Roaming scenarios is not considered.
(NOTE 8)
When the PDU session Type is “Ethernet” or “Unstructured”, this component shall be present.

TABLE 5
SSC mode information element encoding - option 1
SSC mode value (octet 1, bit 1 to bit 4)

| Bits | | | |
|---|---|---|---|
| 3 | 2 | 1 | |
| 0 | 0 | 1 | SSC mode 1 |
| 0 | 1 | 0 | SSC mode 2 |
| 0 | 1 | 1 | SSC mode 3 |
| 1 | 0 | 0 | unused; shall be interpreted as “SSC mode 1”, |
| | | | if received by the network |
| 1 | 0 | 1 | unused; shall be interpreted as “SSC mode 2”, |
| | | | if received by the network |
| 1 | 1 | 0 | unused; shall be interpreted as “SSC mode 3”, |
| | | | if received by the network |
| 1 | 1 | 1 | SSC Mode 4 |

All other values are reserved.

TABLE 6
SSC mode information element encoding - option 2
SSC mode value (octet 1, bit 1 to bit 4)

| Bits | | | |
|---|---|---|---|
| 3 | 2 | 1 | |
| 0 | 0 | 1 | SSC mode 1 |
| 0 | 1 | 0 | SSC mode 2 |
| 0 | 1 | 1 | SSC mode 3 |
| 1 | 0 | 0 | SSC mode 1 with the persistent NAS-SM context feature |
| 1 | 0 | 1 | SSC mode 2 with the persistent NAS-SM context feature |
| 1 | 1 | 0 | SSC mode 3 with the persistent NAS-SM context feature |

All other values are reserved.

What is claimed is:

1. A method implemented by a wireless transmit/receive unit (WTRU) for communications with a network, the method comprising:
sending, by the WTRU to a network node, a registration request message requesting to register with the network, wherein the registration request message comprises an indication that the WTRU is capable of preserving, when the WTRU becomes unavailable to the network, context information associated with the communications between the WTRU and the network;
receiving, by the WTRU from the network node, a registration accept message, wherein the registration accept message comprises an indication that the network supports the preservation of context information when the WTRU becomes unavailable to the network;
sending, by the WTRU to the network based on a determination that the WTRU will become unavailable to the network, a first message indicating a request to preserve the context information, wherein the first message comprises an indication of a time period during which the WTRU will be unavailable; and
after the time period has ended, sending to the network a second message indicating that the WTRU is available to the network.

2. The method of claim 1, further comprising determining that the WTRU will become unavailable to the network due to any one or more of:
a modem reset;
an operating system update;
a software update;
a network-initiated de-registration request;
a WTRU-initiated de-registration request;
a network-initiated N1-reset request;
a WTRU-initiated N1-reset request; or
a change from an RM-REGISTERED state to an RM-DEREGISTERED state.

3. The method of claim 1, wherein the context information comprises non-access stratum (NAS) session management (SM) context information.

4. The method of claim 1, wherein the context information comprises any one or more of:
a protocol data unit (PDU) session identifier;
a data network name (DNN);
single network slice assistance information (S-NSSAI); or
an internet protocol (IP) address.

5. The method of claim 1, wherein the first message indicating the request to preserve the context information comprises one of:
an N1-reset request message; or
a WTRU-initiated deregistration request message.

6. The method of claim 1, wherein the second message indicating that the WTRU is available to the network comprises a second registration request message.

7. The method of claim 1, further comprising sending, to the network, a request to establish a protocol data unit (PDU) session, wherein the request to establish the PDU session comprises an indication that the context information for the PDU session is requested to be preserved when the WTRU becomes unavailable.

8. The method of claim 1, further comprising storing, in the WTRU, the context information prior to the WTRU becoming unavailable.

9. A wireless transmit/receive unit (WTRU) comprising a processor and memory storing instructions that, when executed by the processor, cause the WTRU to perform operations comprising:
sending, to a network node, a registration request message requesting to register with the network, wherein the registration request message comprises an indication that the WTRU is capable of preserving, when the WTRU becomes unavailable to the network, context information associated with communications between the WTRU and the network;
receiving, from the network node, a registration accept message, wherein the registration accept message comprises an indication that the network supports the preservation of context information when the WTRU becomes unavailable to the network;
sending, to the network based on a determination that the WTRU will become unavailable to the network, a first message indicating a request to preserve the context information, wherein the first message comprises an indication of a time period during which the WTRU will be unavailable; and
after the time period has ended, sending to the network a second message indicating that the WTRU is available to the network.

10. The WTRU of claim 9, wherein the instructions, when executed by the processor, further cause the WTRU to determine that the WTRU will become unavailable to the network due to any one or more of:
a modem reset;
an operating system update;
a software update;
a network-initiated de-registration request;
a WTRU-initiated de-registration request;
a network-initiated N1-reset request;
a WTRU-initiated N1-reset request; or
a change from an RM-REGISTERED state to an RM-DEREGISTERED state.

11. The WTRU of claim 9, wherein the context information comprises non-access stratum (NAS) session management (SM) context information.

12. The WTRU of claim 9, wherein the context information comprises any one or more of:
a protocol data unit (PDU) session identifier;
a data network name (DNN);
a single network slice assistance information (S-NSSAI); or
an internet protocol (IP) address.

13. The WTRU of claim 9, wherein the first message indicating the request to preserve the context information comprises one of:
an N1-reset request message; or
a WTRU-initiated deregistration request message.

14. The WTRU of claim 9, wherein the second message indicating that the WTRU is available to the network comprises a second registration request message.

15. The WTRU of claim 9, wherein the instructions, when executed by the processor, further cause the WTRU to send, to the network, a request to establish a protocol data unit (PDU) session, wherein the request to establish the PDU session comprises an indication that the context information associated with the PDU session is requested to be preserved when the WTRU becomes unavailable.

16. The WTRU of claim 9, wherein the instructions, when executed by the processor, further cause the WTRU to store, in the WTRU, the context information prior to the WTRU becoming unavailable.
